(19) United States
(12) Patent Application Publication
(10) Pub. No.: US 2026/0303180 A1
(43) Pub. Date: Oct. 1, 2026

(54) CODEBOOK DESIGNS WITH DIFFERENT OVERSAMPLING FACTORS

(71) Applicant: QUALCOMM Incorporated, San Diego, CA (US)

(72) Inventors: Kexin XIAO, Shanghai (CN); Yi HUANG, San Diego, CA (US); Yu ZHANG, San Diego, CA (US); Hyojin LEE, San Diego, CA (US); Hung Dinh LY, San Diego, CA (US)

(21) Appl. No.: 18/992,104

(22) PCT Filed: Aug. 19, 2022
(86) PCT No.: PCT/CN2022/113620

§ 371 Date: Jan. 7, 2025

(51) Int. Cl. H04B 7/06; H04W 72/21

(52) U.S. Cl. CPC H04B 7/0639; H04W 72/21

(57) ABSTRACT

Aspects relate to codebooks for uplink transmissions. In some examples, different oversampling factors may be used for uplink codebooks and downlink codebooks that are based on the same antenna configuration. In some examples, a user equipment may transmit an indication of an antenna configuration to a network entity. In some examples, a network entity may identify a codebook based on an antenna configuration of a user equipment.

### TECHNICAL FIELD

The technology discussed below relates generally to wireless communication and, more particularly, to using different oversampling factors for different codebooks.

### INTRODUCTION

Next-generation wireless communication systems (e.g., 5GS) may include a 5G core network and a 5G radio access network (RAN), such as a New Radio (NR)-RAN. The NR-RAN supports communication via one or more cells. For example, a wireless communication device such as a user equipment (UE) may access a first cell of a first base station (BS) such as a gNB and/or access a second cell of a second base station.

A base station may schedule access to a cell to support access by multiple UEs. For example, a base station may allocate different resources (e.g., time domain and frequency domain resources) to be used by different UEs operating within the cell.

### BRIEF SUMMARY OF SOME EXAMPLES

The following presents a summary of one or more aspects of the present disclosure, in order to provide a basic understanding of such aspects. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in a form as a prelude to the more detailed description that is presented later.

In some examples, a user equipment may include a memory, and a processor coupled to the memory. The processor and the memory may be configured to receive a transmitted precoder matrix index (TPMI) from a network entity, the TPMI being associated with a first uplink codebook, the first uplink codebook being based on a first antenna configuration of the user equipment and a first oversampling factor. The processor and the memory may also be configured to transmit an uplink transmission based on the TPMI to the network entity.

In some examples, a method for wireless communication at a user equipment is disclosed. The method may include receiving a transmitted precoder matrix index (TPMI) from a network entity, the TPMI being associated with a first uplink codebook, the first uplink codebook being based on a first antenna configuration of the user equipment and a first oversampling factor. The method may also include transmitting an uplink transmission based on the TPMI to the network entity.

In some examples, a user equipment may include means for receiving a transmitted precoder matrix index (TPMI) from a network entity, the TPMI being associated with a first uplink codebook, the first uplink codebook being based on a first antenna configuration of the user equipment and a first oversampling factor. The user equipment may also include means for transmitting an uplink transmission based on the TPMI to the network entity.

In some examples, a non-transitory computer-readable medium has stored therein instructions executable by one or more processors of a user equipment to receive a transmitted precoder matrix index (TPMI) from a network entity, the TPMI being associated with a first uplink codebook, the first uplink codebook being based on a first antenna configuration of the user equipment and a first oversampling factor. The computer-readable medium may also have stored therein instructions executable by one or more processors of the user equipment to transmit an uplink transmission based on the TPMI to the network entity.

In some examples, a user equipment may include a memory, and a processor coupled to the memory. The processor and the memory may be configured to transmit a first indication of a first antenna configuration associated with the user equipment to a network entity. The processor and the memory may also be configured to receive a second indication of a codebook set for uplink transmissions from the network entity, the codebook set being based on the first antenna configuration. The processor and the memory may be further configured to transmit a first uplink transmission based on a first uplink codebook of the codebook set to the network entity.

In some examples, a method for wireless communication at a user equipment is disclosed. The method may include transmitting a first indication of a first antenna configuration associated with the user equipment to a network entity. The method may also include receiving a second indication of a codebook set for uplink transmissions from the network entity, the codebook set being based on the first antenna configuration. The method may further include transmitting a first uplink transmission based on a first uplink codebook of the codebook set to the network entity.

In some examples, a user equipment may include means for transmitting a first indication of a first antenna configuration associated with the user equipment to a network entity. The user equipment may also include means for receiving a second indication of a codebook set for uplink transmissions from the network entity, the codebook set being based on the first antenna configuration. The user equipment may further include means for transmitting a first uplink transmission based on a first uplink codebook of the codebook set to the network entity.

In some examples, a non-transitory computer-readable medium has stored therein instructions executable by one or more processors of a user equipment to transmit a first indication of a first antenna configuration associated with the user equipment to a network entity. The computer-readable medium may also have stored therein instructions executable by one or more processors of the user equipment to receive a second indication of a codebook set for uplink transmissions from the network entity, the codebook set being based on the first antenna configuration. The computer-readable medium may further have stored therein instructions executable by one or more processors of the user equipment to transmit a first uplink transmission based on a first uplink codebook of the codebook set to the network entity.

In some examples, a network entity may include a memory, and a processor coupled to the memory. The processor and the memory may be configured to transmit a transmitted precoder matrix index (TPMI) to a user equipment, the TPMI being associated with a first uplink codebook, the first uplink codebook being based on a first antenna configuration of the user equipment and a first oversampling factor. The processor and the memory may also be configured to receive an uplink transmission based on the TPMI from the user equipment.

In some examples, a method for wireless communication at a network entity is disclosed. The method may include transmitting a transmitted precoder matrix index (TPMI) to a user equipment, the TPMI being associated with a first uplink codebook, the first uplink codebook being based on a first antenna configuration of the user equipment and a first oversampling factor. The method may also include receiving an uplink transmission based on the TPMI from the user equipment.

In some examples, a network entity may include means for transmitting a transmitted precoder matrix index (TPMI) to a user equipment, the TPMI being associated with a first uplink codebook, the first uplink codebook being based on a first antenna configuration of the user equipment and a first oversampling factor. The network entity may also include means for receiving an uplink transmission based on the TPMI from the user equipment.

In some examples, a non-transitory computer-readable medium has stored therein instructions executable by one or more processors of a network entity to transmit a transmitted precoder matrix index (TPMI) to a user equipment, the TPMI being associated with a first uplink codebook, the first uplink codebook being based on a first antenna configuration of the user equipment and a first oversampling factor. The computer-readable medium may also have stored therein instructions executable by one or more processors of the network entity to receive an uplink transmission based on the TPMI from the user equipment.

In some examples, a network entity may include a memory, and a processor coupled to the memory. The processor and the memory may be configured to receive a first indication of a first antenna configuration associated with a user equipment from the user equipment. The processor and the memory may also be configured to transmit a second indication of a codebook set for uplink transmissions to the user equipment, the codebook set being based on the first antenna configuration. The processor and the memory may be further configured to receive a first uplink transmission based on a first uplink codebook of the codebook set from the user equipment.

In some examples, a method for wireless communication at a network entity is disclosed. The method may include receiving a first indication of a first antenna configuration associated with a user equipment from the user equipment. The method may also include transmitting a second indication of a codebook set for uplink transmissions to the user equipment, the codebook set being based on the first antenna configuration. The method may further include receiving a first uplink transmission based on a first uplink codebook of the codebook set from the user equipment.

In some examples, a network entity may include means for receiving a first indication of a first antenna configuration associated with a user equipment from the user equipment. The network entity may also include means for transmitting a second indication of a codebook set for uplink transmissions to the user equipment, the codebook set being based on the first antenna configuration. The network entity may further include means for receiving a first uplink transmission based on a first uplink codebook of the codebook set from the user equipment.

In some examples, a non-transitory computer-readable medium has stored therein instructions executable by one or more processors of a network entity to receive a first indication of a first antenna configuration associated with a user equipment from the user equipment. The computer-readable medium may also have stored therein instructions executable by one or more processors of the network entity to transmit a second indication of a codebook set for uplink transmissions to the user equipment, the codebook set being based on the first antenna configuration. The computer-readable medium may further have stored therein instructions executable by one or more processors of the network entity to receive a first uplink transmission based on a first uplink codebook of the codebook set from the user equipment.

These and other aspects of the disclosure will become more fully understood upon a review of the detailed description, which follows. Other aspects, features, and examples of the present disclosure will become apparent to those of ordinary skill in the art, upon reviewing the following description of specific, example aspects of the present disclosure in conjunction with the accompanying figures. While features of the present disclosure may be discussed relative to certain examples and figures below, all examples of the present disclosure can include one or more of the advantageous features discussed herein. In other words, while one or more examples may be discussed as having certain advantageous features, one or more of such features may also be used in accordance with the various examples of the disclosure discussed herein. In similar fashion, while example aspects may be discussed below as device, system, or method examples it should be understood that such example aspects can be implemented in various devices, systems, and methods.

### BRIEF DESCRIPTION OF THE DRAWINGS

FIG. 1 is a schematic illustration of a wireless communication system according to some aspects.

FIG. 2 is a conceptual illustration of an example of a radio access network according to some aspects.

FIG. 3 is a diagram providing a high-level illustration of one example of a configuration of a disaggregated base station according to some aspects.

FIG. 4 is a schematic illustration of wireless resources in an air interface utilizing orthogonal frequency divisional multiplexing (OFDM) according to some aspects.

FIG. 5 is a diagram illustrating examples of codebooks according to some aspects.

FIG. 6 is a diagram illustrating additional examples of codebooks according to some aspects.

FIG. 7 is a diagram illustrating another example of a codebook according to some aspects.

FIG. 8 is a signaling diagram illustrating an example of signaling associated with communication of codebook-related information according to some aspects.

FIG. 9 is a diagram illustrating indications of layers and transmitted precoder matrix indicators according to some aspects.

FIG. 10 is a conceptual illustration of an antenna configuration according to some aspects.

FIG. 11 is a diagram illustrating an example of different oversampling factors for different antenna configurations according to some aspects.

FIG. 12 is a conceptual illustration of a uniform planar array antenna configuration and a uniform linear array antenna configuration according to some aspects.

FIG. 13 is a signaling diagram illustrating an example of signaling associated with communication of codebook-related information according to some aspects.

FIG. 14 is a block diagram conceptually illustrating an example of a hardware implementation for a user equipment employing a processing system according to some aspects.

FIG. 15 is a flow chart illustrating an example wireless communication method involving codebook-based communication according to some aspects.

FIG. 16 is a flow chart illustrating an example wireless communication method involving transmitting an indication of an antenna configuration according to some aspects.

FIG. 17 is a flow chart illustrating an example wireless communication method involving codebook-based communication according to some aspects.

FIG. 18 is a block diagram conceptually illustrating an example of a hardware implementation for a network entity employing a processing system according to some aspects.

FIG. 19 is a flow chart illustrating an example wireless communication method involving codebook-based communication according to some aspects.

FIG. 20 is a flow chart illustrating an example wireless communication method involving receiving an indication of an antenna configuration according to some aspects.

FIG. 21 is a flow chart illustrating an example wireless communication method involving codebook-based communication according to some aspects.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

While aspects and examples are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, aspects and/or uses may come about via integrated chip examples and other non-module-component based devices (e.g., end-user devices, vehicles, communication devices, computing devices, industrial equipment, retail/purchasing devices, medical devices, artificial intelligence-enabled (AI-enabled) devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described examples. For example, transmission and reception of wireless signals necessarily includes a number of components for analog and digital purposes (e.g., hardware components including antenna, radio frequency (RF) chains, power amplifiers, modulators, buffer, processor(s), interleaver, adders/summers, etc.). It is intended that innovations described herein may be practiced in a wide variety of devices, chip-level components, systems, distributed arrangements, disaggregated arrangements (e.g., base station and/or UE), end-user devices, etc., of varying sizes, shapes, and constitution.

Various aspects of the disclosure relate to codebooks for uplink transmissions. In some examples, codebooks for uplink transmissions may support antenna configurations that have eight antenna elements.

In some examples, different oversampling factors may be used for uplink codebooks and downlink codebooks that are based on the same antenna configuration. For example, a downlink codebook for a 2×2 uniform planar array antenna configuration may be constructed using a first oversampling factor, while an uplink codebook for the 2×2 uniform planar array antenna configuration may be constructed using a second oversampling factor that is different from the first oversampling factor.

In some examples, a user equipment may transmit an indication of an antenna configuration of the user equipment to a network entity. The network entity may then identify an uplink codebook for the user equipment based on the antenna configuration of the user equipment. Thus, the network entity can indicate different codebooks to different user equipment based on the antenna configuration of each user equipment.

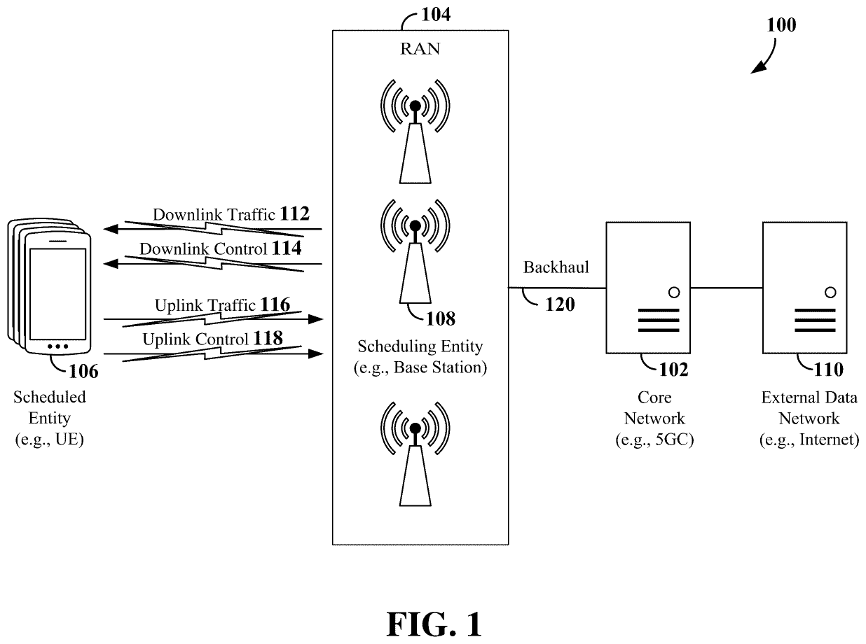

The various concepts presented throughout this disclosure may be implemented across a broad variety of telecommunication systems, network architectures, and communication standards. Referring now to FIG. 1, as an illustrative example without limitation, various aspects of the present disclosure are illustrated with reference to a wireless communication system 100. The wireless communication system 100 includes three interacting domains: a core network 102, a radio access network (RAN) 104, and a user equipment (UE) 106. By virtue of the wireless communication system 100, the UE 106 may be enabled to carry out data communication with an external data network 110, such as (but not limited to) the Internet.

The RAN 104 may implement any suitable wireless communication technology or technologies to provide radio access to the UE 106. As one example, the RAN 104 may operate according to 3rd Generation Partnership Project (3GPP) New Radio (NR) specifications, often referred to as 5G. As another example, the RAN 104 may operate under a hybrid of 5G NR and Evolved Universal Terrestrial Radio Access Network (eUTRAN) standards, often referred to as Long-Term Evolution (LTE). The 3GPP refers to this hybrid RAN as a next-generation RAN, or NG-RAN. In another example, the RAN 104 may operate according to both the LTE and 5G NR standards. Of course, many other examples may be utilized within the scope of the present disclosure.

As illustrated, the RAN 104 includes a plurality of base stations 108. Broadly, a base station is a network element in a radio access network responsible for radio transmission and reception in one or more cells to or from a UE. In different technologies, standards, or contexts, a base station may variously be referred to by those skilled in the art as a base transceiver station (BTS), a radio base station, a radio transceiver, a transceiver function, a basic service set (BSS), an extended service set (ESS), an access point (AP), a Node B (NB), an eNode B (eNB), a gNode B (gNB), a transmission and reception point (TRP), or some other suitable terminology. In some examples, a base station may include two or more TRPs that may be collocated or non-collocated. Each TRP may communicate on the same or different carrier frequency within the same or different frequency band. In examples where the RAN 104 operates according to both the LTE and 5G NR standards, one of the base stations 108 may be an LTE base station, while another base station may be a 5G NR base station.

The radio access network 104 is further illustrated supporting wireless communication for multiple mobile apparatuses. A mobile apparatus may be referred to as user equipment (UE) 106 in 3GPP standards, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. A UE 106 may be an apparatus that provides a user with access to network services. In examples where the RAN 104 operates according to both the LTE and 5G NR standards, the UE 106 may be an Evolved-Universal Terrestrial Radio Access Network-New Radio dual connectivity (EN-DC) UE that is capable of simultaneously connecting to an LTE base station and an NR base station to receive data packets from both the LTE base station and the NR base station.

Within the present document, a mobile apparatus need not necessarily have a capability to move, and may be stationary. The term mobile apparatus or mobile device broadly refers to a diverse array of devices and technologies. UEs may include a number of hardware structural components sized, shaped, and arranged to help in communication; such components can include antennas, antenna arrays, RF chains, amplifiers, one or more processors, etc., electrically coupled to each other. For example, some non-limiting examples of a mobile apparatus include a mobile, a cellular (cell) phone, a smart phone, a session initiation protocol (SIP) phone, a laptop, a personal computer (PC), a notebook, a netbook, a smartbook, a tablet, a personal digital assistant (PDA), and a broad array of embedded systems, e.g., corresponding to an Internet of Things (IoT).

A mobile apparatus may additionally be an automotive or other transportation vehicle, a remote sensor or actuator, a robot or robotics device, a satellite radio, a global positioning system (GPS) device, an object tracking device, a drone, a multi-copter, a quad-copter, a remote control device, a consumer and/or wearable device, such as eyewear, a wearable camera, a virtual reality device, a smart watch, a health or fitness tracker, a digital audio player (e.g., MP3 player), a camera, a game console, etc. A mobile apparatus may additionally be a digital home or smart home device such as a home audio, video, and/or multimedia device, an appliance, a vending machine, intelligent lighting, a home security system, a smart meter, etc. A mobile apparatus may additionally be a smart energy device, a security device, a solar panel or solar array, a municipal infrastructure device controlling electric power (e.g., a smart grid), lighting, water, etc., an industrial automation and enterprise device, a logistics controller, agricultural equipment, etc. Still further, a mobile apparatus may provide for connected medicine or telemedicine support, i.e., health care at a distance. Telehealth devices may include telehealth monitoring devices and telehealth administration devices, whose communication may be given preferential treatment or prioritized access over other types of information, e.g., in terms of prioritized access for transport of critical service data, and/or relevant QoS for transport of critical service data.

Wireless communication between a RAN 104 and a UE 106 may be described as utilizing an air interface. Transmissions over the air interface from a base station (e.g., base station 108) to one or more UEs (e.g., UE 106) may be referred to as downlink (DL) transmission. In some examples, the term downlink may refer to a point-to-multipoint transmission originating at a base station (e.g., base station 108). Another way to describe this point-to-multipoint transmission scheme may be to use the term broadcast channel multiplexing. Transmissions from a UE (e.g., UE 106) to a base station (e.g., base station 108) may be referred to as uplink (UL) transmissions. In some examples, the term uplink may refer to a point-to-point transmission originating at a UE (e.g., UE 106).

In some examples, access to the air interface may be scheduled, wherein a scheduling entity (e.g., a base station 108) of some other type of network entity allocates resources for communication among some or all devices and equipment within its service area or cell. Within the present disclosure, as discussed further below, the scheduling entity may be responsible for scheduling, assigning, reconfiguring, and releasing resources for one or more scheduled entities (e.g., UEs). That is, for scheduled communication, a plurality of UEs 106, which may be scheduled entities, may utilize resources allocated by a scheduling entity (e.g., a base station 108).

Base stations 108 are not the only entities that may function as scheduling entities. That is, in some examples, a UE may function as a scheduling entity, scheduling resources for one or more scheduled entities (e.g., one or more other UEs). For example, UEs may communicate with other UEs in a peer-to-peer or device-to-device fashion and/or in a relay configuration.

As illustrated in FIG. 1, a scheduling entity (e.g., a base station 108) may broadcast downlink traffic 112 to one or more scheduled entities (e.g., a UE 106). Broadly, the scheduling entity is a node or device responsible for scheduling traffic in a wireless communication network, including the downlink traffic 112 and, in some examples, uplink traffic 116 and/or uplink control information 118 from one or more scheduled entities to the scheduling entity. On the other hand, the scheduled entity is a node or device that receives downlink control information 114, including but not limited to scheduling information (e.g., a grant), synchronization or timing information, or other control information from another entity in the wireless communication network such as the scheduling entity.

In addition, the uplink control information 118, downlink control information 114, downlink traffic 112, and/or uplink traffic 116 may be time-divided into frames, subframes, slots, and/or symbols. As used herein, a symbol may refer to a unit of time that, in an orthogonal frequency division multiplexed (OFDM) waveform, carries one resource element (RE) per sub-carrier. A slot may carry 7 or 14 OFDM symbols in some examples. A subframe may refer to a duration of 1 millisecond (ms). Multiple subframes or slots may be grouped together to form a single frame or radio frame. Within the present disclosure, a frame may refer to a predetermined duration (e.g., 10 ms) for wireless transmissions, with each frame consisting of, for example, 10 subframes of 1 ms each. Of course, these definitions are not required, and any suitable scheme for organizing waveforms may be utilized, and various time divisions of the waveform may have any suitable duration.

In general, base stations 108 may include a backhaul interface for communication with a backhaul 120 of the wireless communication system. The backhaul 120 may provide a link between a base station 108 and the core network 102. Further, in some examples, a backhaul network may provide interconnection between the respective base stations 108. Various types of backhaul interfaces may be employed, such as a direct physical connection, a virtual network, or the like using any suitable transport network.

The core network 102 may be a part of the wireless communication system 100, and may be independent of the radio access technology used in the RAN 104. In some examples, the core network 102 may be configured according to 5G standards (e.g., 5GC). In other examples, the core network 102 may be configured according to a 4G evolved packet core (EPC), or any other suitable standard or configuration.

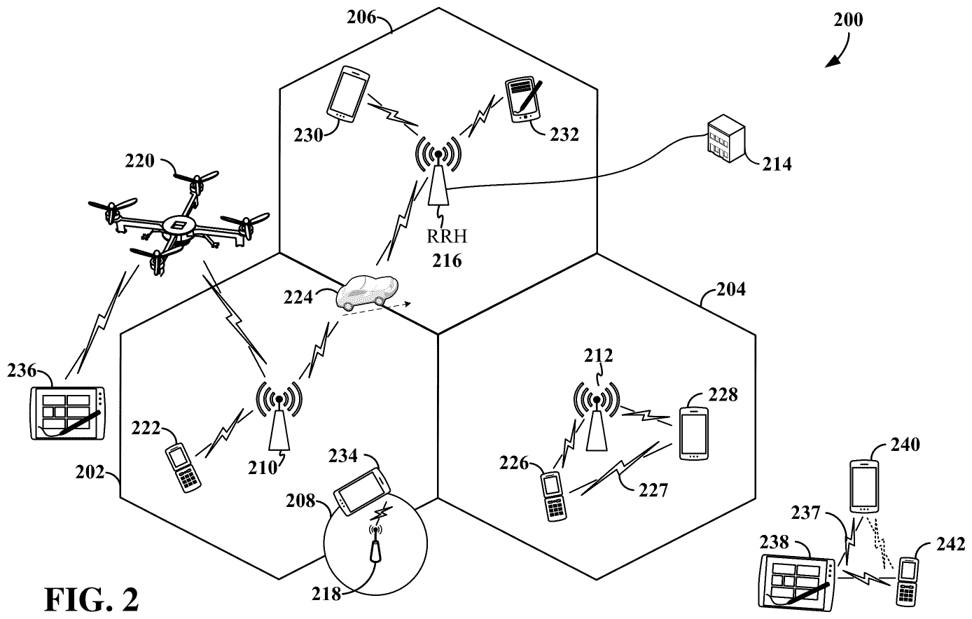

Referring now to FIG. 2, by way of example and without limitation, a schematic illustration of a radio access network (RAN) 200 is provided. In some examples, the RAN 200 may be the same as the RAN 104 described above and illustrated in FIG. 1.

The geographic area covered by the RAN 200 may be divided into cellular regions (cells) that can be uniquely identified by a user equipment (UE) based on an identification broadcasted from one access point or base station. FIG. 2 illustrates cells 202, 204, 206, and 208, each of which may include one or more sectors (not shown). A sector is a sub-area of a cell. All sectors within one cell are served by the same base station. A radio link within a sector can be identified by a single logical identification belonging to that sector. In a cell that is divided into sectors, the multiple sectors within a cell can be formed by groups of antennas with each antenna responsible for communication with UEs in a portion of the cell.

Various base station arrangements can be utilized. For example, in FIG. 2, two base stations 210 and 212 are shown in cells 202 and 204; and a base station 214 is shown controlling a remote radio head (RRH) 216 in cell 206. That is, a base station can have an integrated antenna or can be connected to an antenna or RRH by feeder cables. In the illustrated example, the cells 202, 204, and 206 may be referred to as macrocells, as the base stations 210, 212, and 214 support cells having a large size. Further, a base station 218 is shown in the cell 208, which may overlap with one or more macrocells. In this example, the cell 208 may be referred to as a small cell (e.g., a microcell, picocell, femtocell, home base station, home Node B, home eNode B, etc.), as the base station 218 supports a cell having a relatively small size. Cell sizing can be done according to system design as well as component constraints.

It is to be understood that the RAN 200 may include any number of wireless base stations and cells. Further, a relay node may be deployed to extend the size or coverage area of a given cell. The base stations 210, 212, 214, 218 provide wireless access points to a core network for any number of mobile apparatuses. In some examples, the base stations 210, 212, 214, and/or 218 may be the same as the base station/scheduling entity described above and illustrated in FIG. 1.

FIG. 2 further includes an unmanned aerial vehicle (UAV) 220, which may be a drone or quadcopter. The UAV 220 may be configured to function as a base station, or more specifically as a mobile base station. That is, in some examples, a cell may not necessarily be stationary, and the geographic area of the cell may move according to the location of a mobile base station, such as the UAV 220.

Within the RAN 200, the cells may include UEs that may be in communication with one or more sectors of each cell. Further, each base station 210, 212, 214, and 218 may be configured to provide an access point to a core network 102 (see FIG. 1) for all the UEs in the respective cells. For example, UEs 222 and 224 may be in communication with base station 210; UEs 226 and 228 may be in communication with base station 212; UEs 230 and 232 may be in communication with base station 214 by way of RRH 216; and UE 234 may be in communication with base station 218. In some examples, the UEs 222, 224, 226, 228, 230, 232, 234, 236, 238, 240, and/or 242 may be the same as the UE/scheduled entity described above and illustrated in FIG. 1. In some examples, the UAV 220 (e.g., the quadcopter) can be a mobile network node and may be configured to function as a UE. For example, the UAV 220 may operate within cell 202 by communicating with base station 210.

In a further aspect of the RAN 200, sidelink signals may be used between UEs without necessarily relying on scheduling or control information from a base station. Sidelink communication may be utilized, for example, in a device-to-device (D2D) network, peer-to-peer (P2P) network, vehicle-to-vehicle (V2V) network, vehicle-to-everything (V2X) network, and/or other suitable sidelink network. For example, two or more UEs (e.g., UEs 238, 240, and 242) may communicate with each other using sidelink signals 237 without relaying that communication through a base station. In some examples, the UEs 238, 240, and 242 may each function as a scheduling entity or transmitting sidelink device and/or a scheduled entity or a receiving sidelink device to schedule resources and communicate sidelink signals 237 therebetween without relying on scheduling or control information from a base station. In other examples, two or more UEs (e.g., UEs 226 and 228) within the coverage area of a base station (e.g., base station 212) may also communicate sidelink signals 227 over a direct link (sidelink) without conveying that communication through the base station 212. In this example, the base station 212 may allocate resources to the UEs 226 and 228 for the sidelink communication.

In the RAN 200, the ability for a UE to communicate while moving, independent of its location, is referred to as mobility. The various physical channels between the UE and the radio access network are generally set up, maintained, and released under the control of an access and mobility management function (AMF, not illustrated, part of the core network 102 in FIG. 1), which may include a security context management function (SCMF) that manages the security context for both the control plane and the user plane functionality, and a security anchor function (SEAF) that performs authentication.

A RAN 200 may utilize DL-based mobility or UL-based mobility to enable mobility and handovers (i.e., the transfer of a UE's connection from one radio channel to another). In a network configured for DL-based mobility, during a call with a scheduling entity, or at any other time, a UE may monitor various parameters of the signal from its serving cell as well as various parameters of neighboring cells. Depending on the quality of these parameters, the UE may maintain communication with one or more of the neighboring cells. During this time, if the UE moves from one cell to another, or if signal quality from a neighboring cell exceeds that from the serving cell for a given amount of time, the UE may undertake a handoff or handover from the serving cell to the neighboring (target) cell. For example, UE 224 (illustrated as a vehicle, although any suitable form of UE may be used) may move from the geographic area corresponding to its serving cell (e.g., the cell 202) to the geographic area corresponding to a neighbor cell (e.g., the cell 206). When the signal strength or quality from the neighbor cell exceeds that of the serving cell for a given amount of time, the UE 224 may transmit a reporting message to its serving base station (e.g., the base station 210) indicating this condition. In response, the UE 224 may receive a handover command, and the UE may undergo a handover to the cell 206.

In a network configured for UL-based mobility, UL reference signals from each UE may be utilized by the network to select a serving cell for each UE. In some examples, the base stations 210, 212, and 214/216 may broadcast unified synchronization signals (e.g., unified Primary Synchronization Signals (PSSs), unified Secondary Synchronization Signals (SSSs) and unified Physical Broadcast Channels (PBCH)). The UEs 222, 224, 226, 228, 230, and 232 may receive the unified synchronization signals, derive the carrier frequency and slot timing from the synchronization signals, and in response to deriving timing, transmit an uplink pilot or reference signal. The uplink pilot signal transmitted by a UE (e.g., UE 224) may be concurrently received by two or more cells (e.g., base stations 210 and 214/216) within the RAN 200. Each of the cells may measure a strength of the pilot signal, and the radio access network (e.g., one or more of the base stations 210 and 214/216 and/or a central node within the core network) may determine a serving cell for the UE 224. As the UE 224 moves through the RAN 200, the network may continue to monitor the uplink pilot signal transmitted by the UE 224. When the signal strength or quality of the pilot signal measured by a neighboring cell exceeds that of the signal strength or quality measured by the serving cell, the RAN 200 may handover the UE 224 from the serving cell to the neighboring cell, with or without informing the UE 224.

Although the synchronization signal transmitted by the base stations 210, 212, and 214/216 may be unified, the synchronization signal may not identify a particular cell, but rather may identify a zone of multiple cells operating on the same frequency and/or with the same timing. The use of zones in 5G networks or other next generation communication networks enables the uplink-based mobility framework and improves the efficiency of both the UE and the network, since the number of mobility messages that need to be exchanged between the UE and the network may be reduced.

In various implementations, the air interface in the RAN 200 may utilize licensed spectrum, unlicensed spectrum, or shared spectrum. Licensed spectrum provides for exclusive use of a portion of the spectrum, generally by virtue of a mobile network operator purchasing a license from a government regulatory body. Unlicensed spectrum provides for shared use of a portion of the spectrum without the need for a government-granted license. While compliance with some technical rules is generally still required to access unlicensed spectrum, generally, any operator or device may gain access. Shared spectrum may fall between licensed and unlicensed spectrum, wherein technical rules or limitations may be required to access the spectrum, but the spectrum may still be shared by multiple operators and/or multiple radio access technologies (RATs). For example, the holder of a license for a portion of licensed spectrum may provide licensed shared access (LSA) to share that spectrum with other parties, e.g., with suitable licensee-determined conditions to gain access.

The air interface in the RAN 200 may utilize one or more multiplexing and multiple access algorithms to enable simultaneous communication of the various devices. For example, 5G NR specifications provide multiple access for UL transmissions from UEs 222 and 224 to base station 210, and for multiplexing for DL transmissions from base station 210 to one or more UEs 222 and 224, utilizing orthogonal frequency division multiplexing (OFDM) with a cyclic prefix (CP). In addition, for UL transmissions, 5G NR specifications provide support for discrete Fourier transform-spread-OFDM (DFT-s-OFDM) with a CP (also referred to as single-carrier FDMA (SC-FDMA)). However, within the scope of the present disclosure, multiplexing and multiple access are not limited to the above schemes, and may be provided utilizing time division multiple access (TDMA), code division multiple access (CDMA), frequency division multiple access (FDMA), sparse code multiple access (SCMA), resource spread multiple access (RSMA), or other suitable multiple access schemes. Further, multiplexing DL transmissions from the base station 210 to UEs 222 and 224 may be provided utilizing time division multiplexing (TDM), code division multiplexing (CDM), frequency division multiplexing (FDM), orthogonal frequency division multiplexing (OFDM), sparse code multiplexing (SCM), or other suitable multiplexing schemes.

The air interface in the RAN 200 may further utilize one or more duplexing algorithms. Duplex refers to a point-to-point communication link where both endpoints can communicate with one another in both directions. Full-duplex means both endpoints can simultaneously communicate with one another. Half-duplex means only one endpoint can send information to the other at a time. Half-duplex emulation is frequently implemented for wireless links utilizing time division duplex (TDD). In TDD, transmissions in different directions on a given channel are separated from one another using time division multiplexing. That is, at some times the channel is dedicated for transmissions in one direction, while at other times the channel is dedicated for transmissions in the other direction, where the direction may change very rapidly, e.g., several times per slot. In a wireless link, a full-duplex channel generally relies on physical isolation of a transmitter and receiver, and suitable interference cancelation technologies. Full-duplex emulation is frequently implemented for wireless links by utilizing frequency division duplex (FDD) or spatial division duplex (SDD). In FDD, transmissions in different directions operate at different carrier frequencies. In SDD, transmissions in different directions on a given channel are separate from one another using spatial division multiplexing (SDM). In other examples, full-duplex communication may be implemented within unpaired spectrum (e.g., within a single carrier bandwidth), where transmissions in different directions occur within different sub-bands of the carrier bandwidth. This type of full-duplex communication may be referred to as sub-band full-duplex (SBFD), cross-division duplex (xDD), or flexible duplex.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CUs, the DUs, and the RUs also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

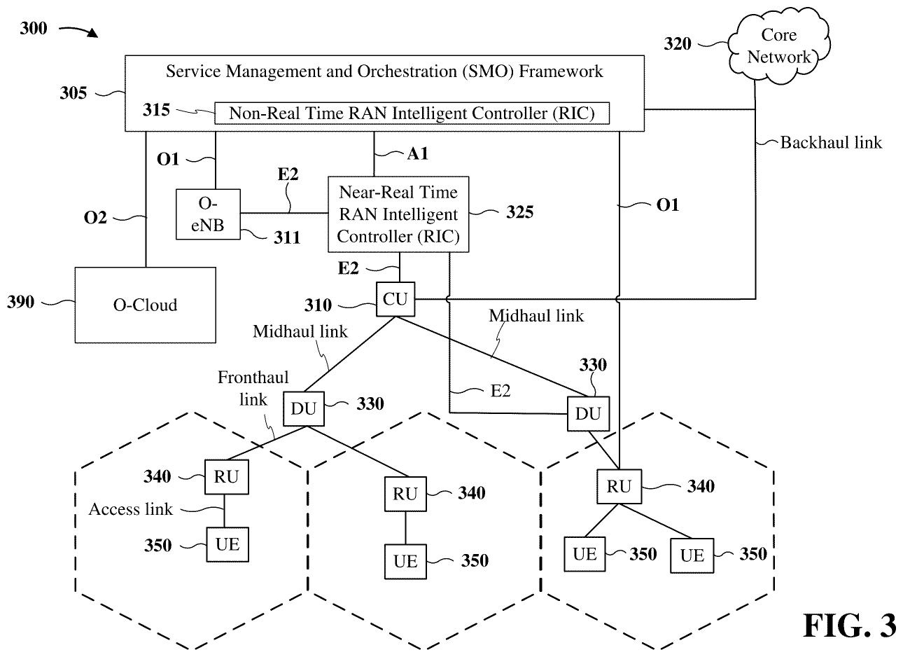

FIG. 3 shows a diagram illustrating an example disaggregated base station 300 architecture. The disaggregated base station 300 architecture may include one or more central units (CUs) 310 that can communicate directly with a core network 320 via a backhaul link, or indirectly with the core network 320 through one or more disaggregated base station units (such as a Near-Real Time (Near-RT) RAN Intelligent Controller (RIC) 325 via an E2 link, or a Non-Real Time (Non-RT) RIC 315 associated with a Service Management and Orchestration (SMO) Framework 305, or both). A CU 310 may communicate with one or more distributed units (DUs) 330 via respective midhaul links, such as an F1 interface. The DUs 330 may communicate with one or more radio units (RUs) 340 via respective fronthaul links. The RUs 340 may communicate with respective UEs 350 via one or more radio frequency (RF) access links. In some implementations, the UE 350 may be simultaneously served by multiple RUs 340.

Each of the units, i.e., the CUS 310, the DUs 330, the RUs 340, as well as the Near-RT RICs 325, the Non-RT RICs 315 and the SMO Framework 305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (i.e., Central Unit-User Plane (CU-UP)), control plane functionality (i.e., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the distributed unit (DU) 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 350. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340 and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via O1) or via creation of RAN management policies (such as A1 policies).

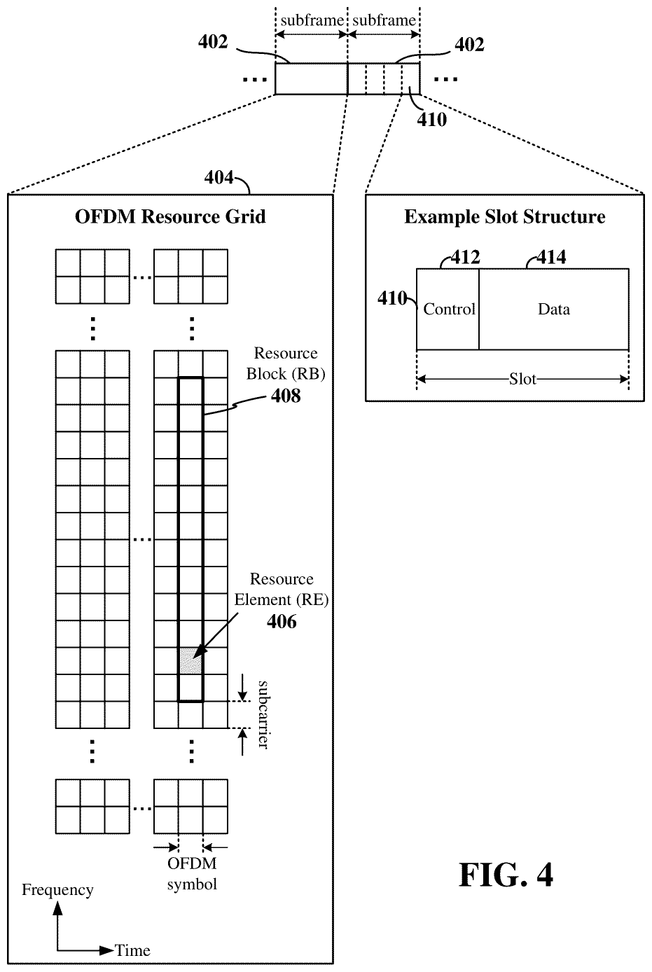

Various aspects of the present disclosure will be described with reference to an OFDM waveform, an example of which is schematically illustrated in FIG. 4. It should be understood by those of ordinary skill in the art that the various aspects of the present disclosure may be applied to an SC-FDMA waveform in substantially the same way as described herein below. That is, while some examples of the present disclosure may focus on an OFDM link for clarity, it should be understood that the same principles may be applied as well to SC-FDMA waveforms.

Referring now to FIG. 4, an expanded view of an example subframe 402 is illustrated, showing an OFDM resource grid. However, as those skilled in the art will readily appreciate, the physical (PHY) layer transmission structure for any particular application may vary from the example described here, depending on any number of factors. Here, time is in the horizontal direction with units of OFDM symbols; and frequency is in the vertical direction with units of subcarriers of the carrier.

The resource grid 404 may be used to schematically represent time-frequency resources for a given antenna port. In some examples, an antenna port is a logical entity used to map data streams to one or more antennas. Each antenna port may be associated with a reference signal (e.g., which may allow a receiver to distinguish data streams associated with the different antenna ports in a received transmission). An antenna port may be defined such that the channel over which a symbol on the antenna port is conveyed can be inferred from the channel over which another symbol on the same antenna port is conveyed. Thus, a given antenna port may represent a specific channel model associated with a particular reference signal. In some examples, a given antenna port and sub-carrier spacing (SCS) may be associated with a corresponding resource grid (including REs as discussed above). Here, modulated data symbols from multiple-input-multiple-output (MIMO) layers may be combined and re-distributed to each of the antenna ports, then precoding is applied, and the precoded data symbols are applied to corresponding REs for OFDM signal generation and transmission via one or more physical antenna elements. In some examples, the mapping of an antenna port to a physical antenna may be based on beamforming (e.g., a signal may be transmitted on certain antenna ports to form a desired beam). Thus, a given antenna port may correspond to a particular set of beamforming parameters (e.g., signal phases and/or amplitudes).

In a MIMO implementation with multiple antenna ports available, a corresponding multiple number of resource grids 404 may be available for communication. The resource grid 404 is divided into multiple resource elements (REs) 406. An RE, which is 1 subcarrier× 1 symbol, is the smallest discrete part of the time-frequency grid, and contains a single complex value representing data from a physical channel or signal. Depending on the modulation utilized in a particular implementation, each RE may represent one or more bits of information. In some examples, a block of REs may be referred to as a physical resource block (PRB) or more simply a resource block (RB) 408, which contains any suitable number of consecutive subcarriers in the frequency domain. In one example, an RB may include 12 subcarriers, a number independent of the numerology used. In some examples, depending on the numerology, an RB may include any suitable number of consecutive OFDM symbols in the time domain. Within the present disclosure, it is assumed that a single RB such as the RB 408 entirely corresponds to a single direction of communication (either transmission or reception for a given device).

A set of continuous or discontinuous resource blocks may be referred to herein as a Resource Block Group (RBG), sub-band, or bandwidth part (BWP). A set of sub-bands or BWPs may span the entire bandwidth. Scheduling of scheduled entities (e.g., UEs) for downlink, uplink, or sidelink transmissions typically involves scheduling one or more resource elements 406 within one or more sub-bands or bandwidth parts (BWPs). Thus, a UE generally utilizes only a subset of the resource grid 404. In some examples, an RB may be the smallest unit of resources that can be allocated to a UE. Thus, the more RBs scheduled for a UE, and the higher the modulation scheme chosen for the air interface, the higher the data rate for the UE. The RBs may be scheduled by a scheduling entity, such as a network entity (e.g., gNB, eNB, etc.), or may be self-scheduled by a UE implementing D2D sidelink communication.

In this illustration, the RB 408 is shown as occupying less than the entire bandwidth of the subframe 402, with some subcarriers illustrated above and below the RB 408. In a given implementation, the subframe 402 may have a bandwidth corresponding to any number of one or more RBs 408. Further, in this illustration, the RB 408 is shown as occupying less than the entire duration of the subframe 402, although this is merely one possible example.

Each 1 ms subframe 402 may consist of one or multiple adjacent slots. In the example shown in FIG. 4, one subframe 402 includes four slots 410, as an illustrative example. In some examples, a slot may be defined according to a specified number of OFDM symbols with a given cyclic prefix (CP) length. For example, a slot may include 7 or 14 OFDM symbols with a nominal CP. Additional examples may include mini-slots, sometimes referred to as shortened transmission time intervals (TTIs), having a shorter duration (e.g., one to three OFDM symbols). These mini-slots or shortened transmission time intervals (TTIs) may in some cases be transmitted occupying resources scheduled for ongoing slot transmissions for the same or for different UEs. Any number of resource blocks may be utilized within a subframe or slot.

An expanded view of one of the slots 410 illustrates the slot 410 including a control region 412 and a data region 414. In general, the control region 412 may carry control channels, and the data region 414 may carry data channels. Of course, a slot may contain all DL, all UL, or at least one DL portion and at least one UL portion. The structure illustrated in FIG. 4 is merely an example, and different slot structures may be utilized, and may include one or more of each of the control region(s) and data region(s).

Although not illustrated in FIG. 4, the various REs 406 within an RB 408 may be scheduled to carry one or more physical channels, including control channels, shared channels, data channels, etc. Other REs 406 within the RB 408 may also carry pilots or reference signals. These pilots or reference signals may provide for a receiving device to perform channel estimation of the corresponding channel, which may enable coherent demodulation/detection of the control and/or data channels within the RB 408.

In some examples, the slot 410 may be utilized for broadcast, multicast, groupcast, or unicast communication. For example, a broadcast, multicast, or groupcast communication may refer to a point-to-multipoint transmission by one device (e.g., a network entity, UE, or other similar device) to other devices. Here, a broadcast communication is delivered to all devices, whereas a multicast or groupcast communication is delivered to multiple intended recipient devices. A unicast communication may refer to a point-to-point transmission by a one device to a single other device.

In an example of cellular communication over a cellular carrier via a Uu interface, for a DL transmission, the scheduling entity (e.g., a network entity) may allocate one or more REs 406 (e.g., within the control region 412) to carry DL control information including one or more DL control channels, such as a physical downlink control channel (PDCCH), to one or more scheduled entities (e.g., UEs). The PDCCH carries downlink control information (DCI) including but not limited to power control commands (e.g., one or more open loop power control parameters and/or one or more closed loop power control parameters), scheduling information, a grant, and/or an assignment of REs for DL and UL transmissions. The PDCCH may further carry hybrid automatic repeat request (HARQ) feedback transmissions such as an acknowledgment (ACK) or negative acknowledgment (NACK). HARQ is a technique well-known to those of ordinary skill in the art, wherein the integrity of packet transmissions may be checked at the receiving side for accuracy, e.g., utilizing any suitable integrity checking mechanism, such as a checksum or a cyclic redundancy check (CRC). If the integrity of the transmission is confirmed, an ACK may be transmitted, whereas if not confirmed, a NACK may be transmitted. In response to a NACK, the transmitting device may send a HARQ retransmission, which may implement chase combining, incremental redundancy, etc.

The network entity may further allocate one or more REs 406 (e.g., in the control region 412 or the data region 414) to carry other DL signals, such as a demodulation reference signal (DMRS); a phase-tracking reference signal (PT-RS); a channel state information (CSI) reference signal (CSI-RS); and a synchronization signal block (SSB). SSBs may be broadcast at regular intervals based on a periodicity (e.g., 5, 10, 20, 30, 80, or 130 ms). An SSB includes a primary synchronization signal (PSS), a secondary synchronization signal (SSS), and a physical broadcast control channel (PBCH). A UE may utilize the PSS and SSS to achieve radio frame, subframe, slot, and symbol synchronization in the time domain, identify the center of the channel (system) bandwidth in the frequency domain, and identify the physical cell identity (PCI) of the cell.

The PBCH in the SSB may further include a master information block (MIB) that includes various system information, along with parameters for decoding a system information block (SIB). The SIB may be, for example, a SystemInformationType 1 (SIB1) that may include various additional (remaining) system information. The MIB and SIB1 together provide the minimum system information (SI) for initial access. Examples of system information transmitted in the MIB may include, but are not limited to, a subcarrier spacing (e.g., default downlink numerology), system frame number, a configuration of a PDCCH control resource set (CORESET) (e.g., PDCCH CORESET0), a cell barred indicator, a cell reselection indicator, a raster offset, and a search space for SIB1. Examples of remaining minimum system information (RMSI) transmitted in the SIB1 may include, but are not limited to, a random access search space, a paging search space, downlink configuration information, and uplink configuration information. A network entity may transmit other system information (OSI) as well.

In an UL transmission, the UE may utilize one or more REs 406 to carry UL control information (UCI) including one or more UL control channels, such as a physical uplink control channel (PUCCH), to the scheduling entity. UCI may include a variety of packet types and categories, including pilots, reference signals, and information configured to enable or assist in decoding uplink data transmissions. Examples of uplink reference signals may include a sounding reference signal (SRS) and an uplink DMRS. In some examples, the UCI may include a scheduling request (SR), i.e., request for the scheduling entity to schedule uplink transmissions. Here, in response to the SR transmitted on the UCI, the scheduling entity may transmit downlink control information (DCI) that may schedule resources for uplink packet transmissions. UCI may also include HARQ feedback, channel state feedback (CSF), such as a CSI report, or any other suitable UCI.

In addition to control information, one or more REs 406 (e.g., within the data region 414) may be allocated for data traffic. Such data traffic may be carried on one or more traffic channels, such as, for a DL transmission, a physical downlink shared channel (PDSCH); or for an UL transmission, a physical uplink shared channel (PUSCH). In some examples, one or more REs 406 within the data region 414 may be configured to carry other signals, such as one or more SIBs and DMRSs.

In an example of sidelink communication over a sidelink carrier via a proximity service (ProSe) PC5 interface, the control region 412 of the slot 410 may include a physical sidelink control channel (PSCCH) including sidelink control information (SCI) transmitted by an initiating (transmitting) sidelink device (e.g., a transmitting (Tx) V2X device or other Tx UE) towards a set of one or more other receiving sidelink devices (e.g., a receiving (Rx) V2X device or some other Rx UE). The data region 414 of the slot 410 may include a physical sidelink shared channel (PSSCH) including sidelink data traffic transmitted by the initiating (transmitting) sidelink device within resources reserved over the sidelink carrier by the transmitting sidelink device via the SCI. Other information may further be transmitted over various REs 406 within slot 410. For example, HARQ feedback information may be transmitted in a physical sidelink feedback channel (PSFCH) within the slot 410 from the receiving sidelink device to the transmitting sidelink device. In addition, one or more reference signals, such as a sidelink SSB, a sidelink CSI-RS, a sidelink SRS, and/or a sidelink positioning reference signal (PRS) may be transmitted within the slot 410.

These physical channels described above are generally multiplexed and mapped to transport channels for handling at the medium access control (MAC) layer. Transport channels carry blocks of information called transport blocks (TB). The transport block size (TBS), which may correspond to a number of bits of information, may be a controlled parameter, based on the modulation and coding scheme (MCS) and the number of RBs in a given transmission.

The channels or carriers described above with reference to FIGS. 1-4 are not necessarily all of the channels or carriers that may be utilized between a scheduling entity and scheduled entities, and those of ordinary skill in the art will recognize that other channels or carriers may be utilized in addition to those illustrated, such as other traffic, control, and feedback channels.

In some examples, uplink transmissions by a user equipment (UE) may be based on a codebook. In some aspects, a codebook may specify a set of precoder matrices. Conventionally, a precoder matrix may be referred to as a precoder.

In some aspects, a precoder may map a set of values (e.g., zeros, ones, etc.) to another set of values (e.g., a set of complex values) for transmission (e.g., via antenna ports). A precoder may take different forms in different examples. For example, a first precoder may take the form [0,1,0,1]^{T}, a second precoder may take the form [0,1,0,j]^{T}, a third precoder may take the form [0,1,0,−j]^{T}, and so on. In some examples, different precoders may be defined for different numbers of antenna ports, different number of antenna elements, different numbers of MIMO layers, or other parameters. In some examples, codebooks and associated precoders are predefined (e.g., defined by a wireless communication standard). In some examples, the codebooks and associated precoders are determine algorithmically (e.g., based on algorithms and parameters defined by a wireless communication standard).

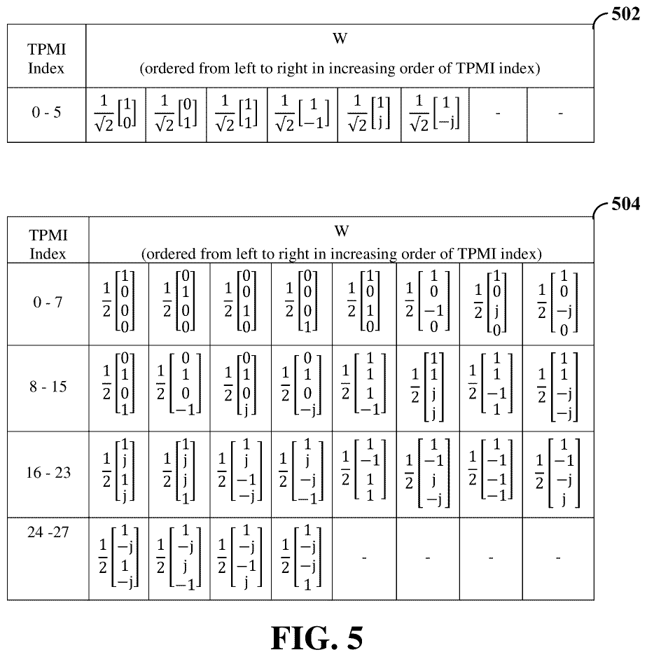

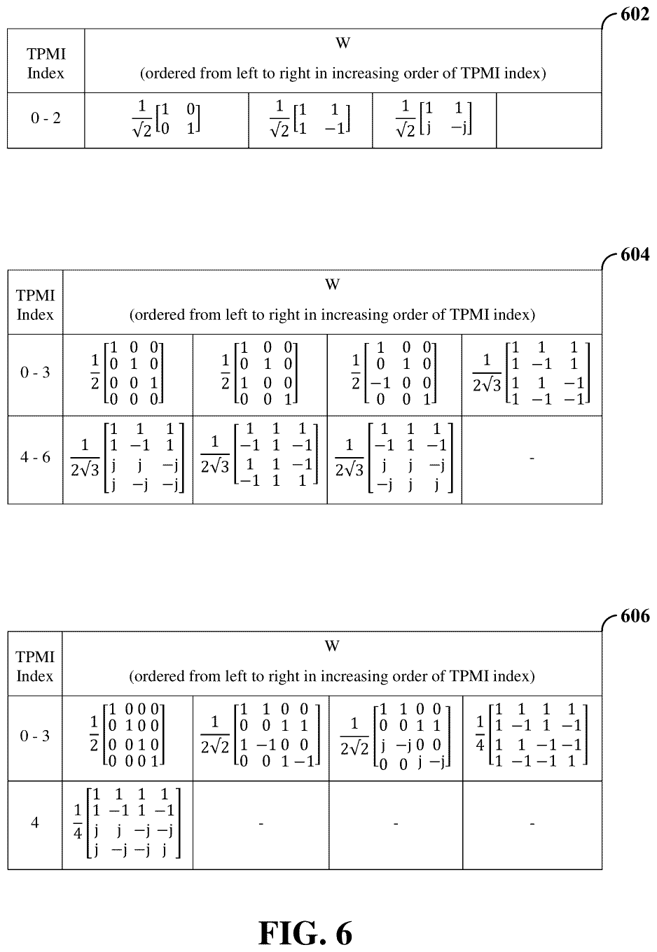

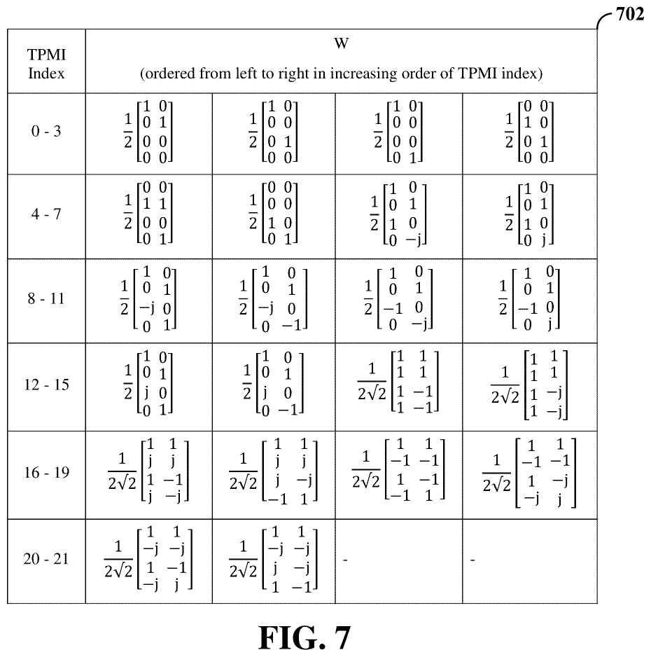

FIGS. 5-7 illustrates several examples of codebooks that may be used for uplink transmissions. A codebook 502 shown in FIG. 5 may be used for a rank 1 (single layer) discrete Fourier transform-spread-OFDM (DFT-S-OFDM) transmission using two antenna elements, or used for a rank 1 cyclic prefix OFDM (CP-OFDM) transmission using two antenna elements. A codebook 504 shown in FIG. 5 may be used, at least in part, for a rank 1 (single layer) DFT-S-OFDM transmission using four antenna elements. A codebook 602 shown in FIG. 6 may be used for a rank 2 (two layer) CP-OFDM transmission using two antenna elements. A codebook 604 shown in FIG. 6 may be used, at least in part, for a rank 3 (three layer) CP-OFDM transmission using four antenna elements. A codebook 606 shown in FIG. 6 may be used, at least in part, for a rank 4 (four layer) CP-OFDM transmission using four antenna elements. A codebook 702 shown in FIG. 7 may be used, at least in part, for a rank 2 CP-OFDM transmission using four antenna elements. Other codebooks may be used in other examples.

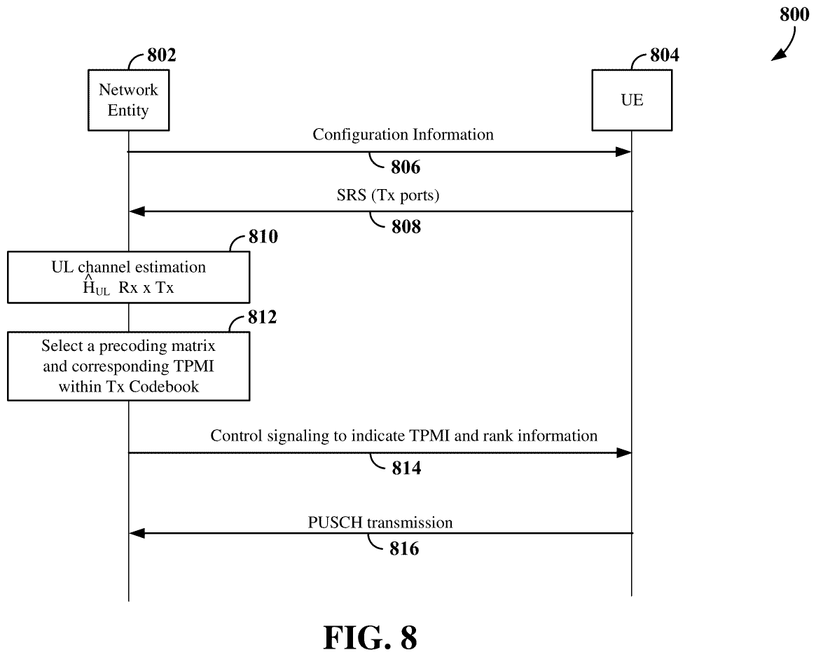

FIG. 8 is a signaling diagram 800 illustrating an example of signaling associated with communication of codebook-related information in a wireless communication system including a network entity 802 and a user equipment 804. In some examples, the network entity 802 may correspond to any of the network entities, base stations, CUs, DUs, RUs, or scheduling entities shown in any of FIGS. 1, 2, 3, 13, and 18. In some examples, the user equipment 804 may correspond to any of the UEs or scheduled entities shown in any of FIGS. 1, 2, 3, 13, and 14.

At 806 of FIG. 8, the network entity 802 transmits configuration information to the user equipment 804 (e.g., via broadcast information and/or RRC signaling). In some examples, this configuration information may indicate the different codebooks and associated precoders that could be used for uplink transmissions and/or downlink transmissions. In some examples, this configuration information may include SRS configuration information that specifies the SRS resources and other parameters to be used by the user equipment 804 to transmit an SRS. For example, the network entity 802 may configure one or more SRS resource sets for the user equipment 804.

At 808, the user equipment 804 transmits sounding reference signals to the network entity 802 via one or more antenna ports. In some examples, the user equipment 804 may use different resource sets for transmitting on different symbols. A defined number of antenna ports may be used for each SRS resource in some examples.

At 810, the network entity 802 estimates the uplink channel (H) from the user equipment 804 to the network entity 802 based on the sounding reference signals received at 808. For example, since the SRS is a known signal, the network entity 802 may estimate the channel based on the known transmitted (Tx) signal and the received (Rx) signal (affected by the channel).

At 812, the network entity 802 selects a precoding matrix within an uplink codebook for an uplink transmission by the user equipment 804. For example, the network entity 802 may determine which precoding matrix will provide the best performance for an uplink transmission that is being scheduled. The selected precoding matrix is then mapped to a corresponding transmitted precoder matrix index (TPMI) value.

At 814, the network entity 802 transmits control signaling to the user equipment 804, where the control signaling indicates the TPMI selected at 812 and associated rank information for the uplink transmission. For example, the network entity may transmit a DCI 0_1 that includes a TPMI field to the user equipment 804 to schedule a PDSCH transmission.

At 816, the user equipment 804 transmits a physical uplink shared channel transmission to the network entity 802 using the TPMI and rank information received at 812. For example, using the TPMI received at 814, the user equipment 804 may identify the precoder to be used for the PUSCH transmission from a configured codebook (e.g., configured at 806).

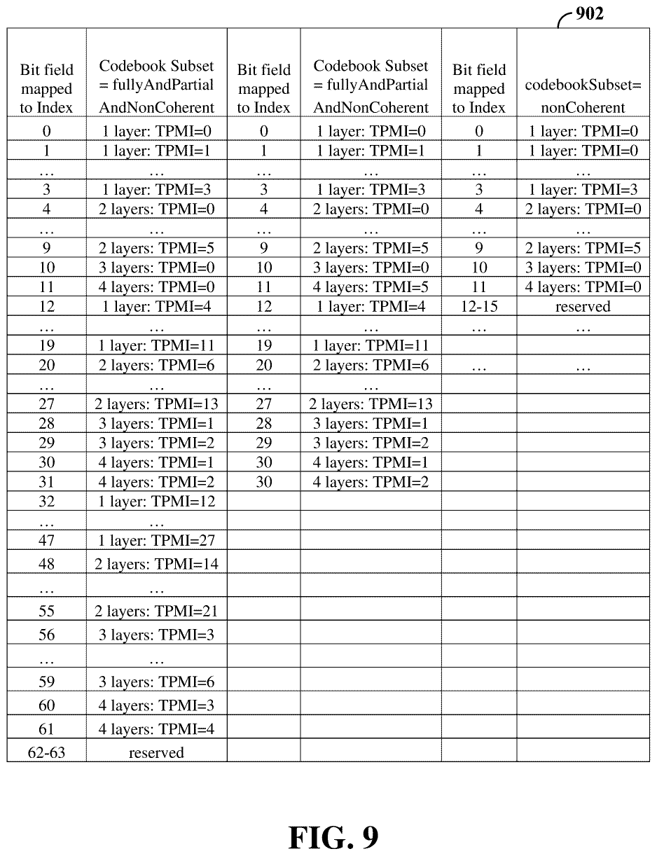

FIG. 9 illustrates an example of TPMI and layer information 902 that a network entity may signal to a UE through the use of a bit field. Here, a given bit field value (e.g., 0 . . . 61) may map to a corresponding number of layers and a particular TPMI index. For example, a value of nine (9) in the first column maps to two layers and a TPMI value of five (5).

Some wireless communication devices may include a relatively large number of antennas and, consequently, a relatively large number of antenna ports. Examples of such apparatuses include, without limitation, customer premises equipment (CPE), fixed wireless access (FWA) devices, vehicle-based communication devices, and industrial communication devices.

The disclosure relates in some aspects to codebooks designs applicable to a relatively large number of antenna ports. For example, several uplink codebook designs are described herein for scenarios where a UE uses eight antenna ports for an uplink transmission.

The disclosure relates in some aspects to using existing codebook designs (e.g., a 3GPP NR Rel-15 downlink (DL) Type I codebook) as a starting point for the design of an eight port codebook for fully-coherent (FC) UEs. Directly reusing an NR DL codebook for an eight port UL codebook design may have several drawbacks. For example, the TPMI size for the NR DL codebook is relatively large. Thus, using this TPMI design will result in relatively high signaling overhead associated with transmitting the TPMI indication. In addition, the NR DL codebook specifies relatively large oversampling factors when a large number of ports are used. This introduces non-quadrature phase shift keying (non-QPSK) elements in the precoding matrix, which increases the complexity of the hardware that performs codebook related operations. For example, a precoding matrix with elements in {+1, −1, j, −j) would be preferable from implementation perspective compared to a precoding matrix that include more complex elements.

In an NR Type-I codebook, precoding vectors are generated by Kronecker product of horizontal and vertical discrete Fourier transform (DFT) vectors. For example, N₁O₁ DFT vectors may be specified for the horizontal domain and N₂O₂ DFT vectors may be defined for the vertical domain.

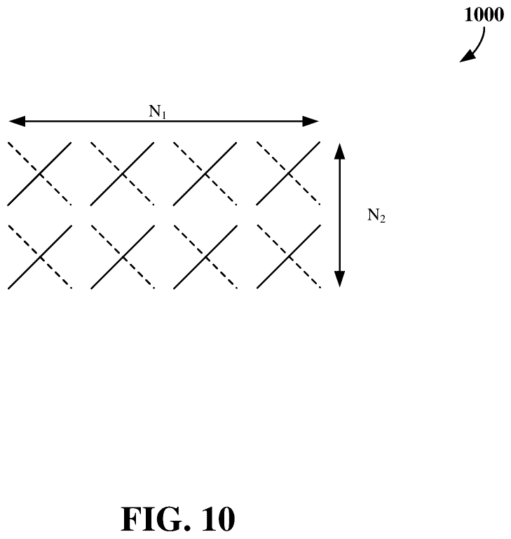

The parameters N₁ and N₂ refer to the number of antenna elements in the horizontal domain and the vertical domain, respectively. FIG. 10 illustrates an example of an antenna configuration 1000 where the number (N₁) of antenna elements in the horizontal domain is four (4) and the number (N₂) of antenna elements in the vertical domain is two (2).

In some examples, a codebook is defined based on two matrices W1 and W2. For such a W1W2 codebook structure, the matrix W1 is associated with beam group selection. For rank-1, closely spaced horizontal and vertical DFT vectors are selected. For higher ranks, orthogonal pairs of horizontal and vertical DFT vectors are selected. The matrix W2 is associated with beam selection and co-phasing between different poles.

The parameters O₁ and O₂ refer to the oversampling factors in the horizontal domain and the vertical domain, respectively. In some aspects, an oversampling factor relates to the granularity of a beam sweep in the corresponding domain. For example, a higher oversampling factor provides a beam sweep with higher granularity.

A component beamforming vector may be generated according to Equation 1.

$${v}_{l , m} = {x}_{l} ⊗ {u}_{m} \\ {\tilde{v}}_{l , m} = {\tilde{x}}_{l} ⊗ {u}_{m} \\ {x}_{l} = {[ \begin{matrix}{e}^{\frac{j 2 π l}{{O}_{1} {N}_{1}}} & … & {e}^{\frac{j 2 π l ( {N}_{1} - 1 )}{{O}_{1} {N}_{1}}}\end{matrix} ]}^{T} \\ {\tilde{x}}_{l} = {[ \begin{matrix}{e}^{\frac{j 4 π l}{{O}_{1} {N}_{1}}} & … & {e}^{\frac{j 4 π l ( {N}_{1} / 2 - 1 )}{{O}_{1} {N}_{1}}}\end{matrix} ]}^{T} \\ {u}_{m} = {[ \begin{matrix}{e}^{\frac{j 2 π m}{{O}_{2} {N}_{2}}} & … & {e}^{\frac{j 2 π m ( {N}_{2} - 1 )}{{O}_{2} {N}_{2}}}\end{matrix} ]}^{T} \\ \text{Co-phasing factor:} {φ}_{n} = {e}^{j π n / 2} , {θ}_{p} = {e}^{j π p / 4} \qquad EQUATION 1$$

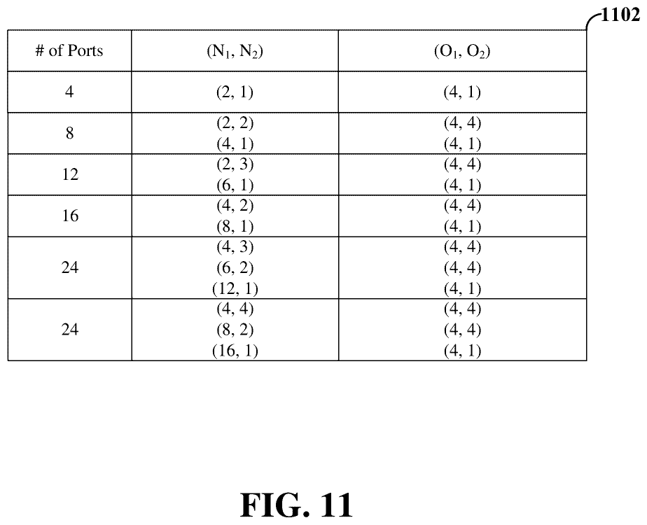

FIG. 11 illustrates an example of mappings of the number of antenna ports and the antenna configuration to particular oversampling factors. For example, for a transmission using eight (8) ports and a 2×2 (N₁=N₂₌₂) antenna array, O₁=4=O₂=4. As another example, for a transmission using twelve (12) ports and a 6×1 (N₁=6, N₂=1) antenna array, O₁=4, and O₂=1.

The disclosure relates in some aspects to eight port UL FC codebook designs for different antenna layouts (e.g., for FWA devices and/or other wireless communication devices). In some examples, a discrete Fourier transform (DFT) codebook is defined with a smaller oversampling factor (e.g., as compared to a conventional NR DL codebook) to provide precoding matrices that have relatively simple quadrature phase shift keying (QPSK) elements. For example, oversampling factors O₁ and O₂ with a value of two (2) may be specified for a uniform plane array (UPA) antenna structure. As another example, an oversampling factor O₁ with a value of one (1) may be specified for a uniform linear array (ULA) antenna structure. In some aspects, the use of smaller oversampling factors may result in negligible loss in terms of the system level throughput performance as compared to the system level throughput performance when larger oversampling factors are used. In addition, the use of smaller oversampling factors may result in a smaller size of the TPMI (e.g., the size of the TPMI may be one fourth the size of a TPMI when a larger oversampling factor is used).

The disclosure also relates in some aspects to indicating the UE antenna structure to network entity. In this way, the network entity may define different codebook sets for different antenna structure. Thus, UEs with different antenna structures can be indicated with different codebook sets.

In a first example, for a UPA (N1=2,N2=2) cross-pole (XPOL) layout, the FC codebook would conventionally be constructed based on the NR DFT codewords with oversampling factor 01=02-4. To provide a precoding matrix with elements in {+1, −1, j, −j}, however, the oversampling factors are instead reduced to 01-02-2. In this case, the TPMI size is only a quarter of the TPMI size of O₁=O₂=4. To further reduce the TPMI size, the oversampling factors may be reduced to O₁−O₂=1.

In a second example, for a ULA (N1=4,N2=1) XPOL layout, the FC codebook would conventionally be constructed based on the NR DFT codewords with oversampling factor O₁=4, O₂=1. To provide a precoding matrix with elements in {+1, −1, j, −j}, however, the oversampling factors are reduced with O₁=1.

In a third example, for a codebook-based UL transmission, different UL codebook sets (e.g., 8Tx codebook sets) can be indicated to the UE based on the UE's antenna structure. Here, the UE can report its antenna structure before the SRS transmission for UL PUSCH scheduling. Upon receiving this antenna configuration information, a network entity may first indicate the select codebook set (e.g., via RRC, MAC-CE, or DCI signaling) before indicating the TPMI to the UE.

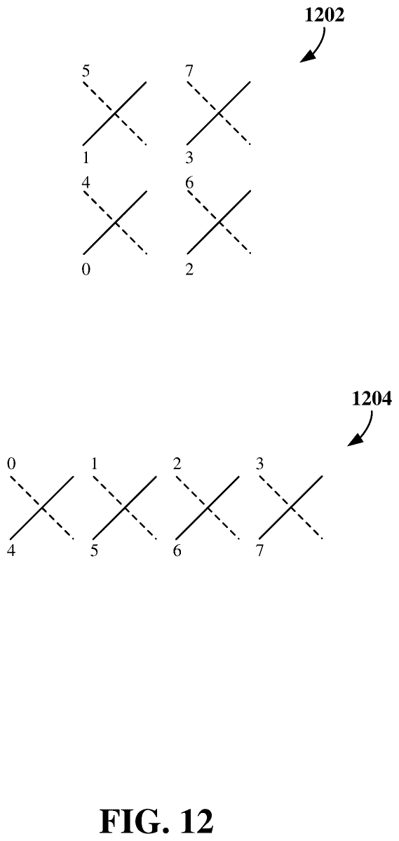

Several examples of eight element (8Tx) uplink codebooks for the 2×2 uniform planar array (UPA) 1202 layout illustrated in FIG. 12 follow. The UPA 1202 include cross-pole antenna elements (e.g., antenna elements 1 and 5 have different polarizations) such that the total number of antenna elements is eight (8).

One example uses, as a starting point for an 8Tx (eight antenna element), Rank 1, UL codebook for a UPA antenna structure, an NR DL codebook for UPA (N₁=2, N₂=2) XPOL layout, with mode=1, O₁=O₂=4, where N₁O₁×N₂O₂ (the number of co-phasing values (i₂))=8×8×4=256 precoders. In some examples, to provide a precoding matrix with elements in {+1, −1, j, −j}, the oversampling factors are reduced with O₁=O₂=2, thereby reducing the number of precoders to 64 precoders. In some examples, to further reduce the TPMI size, the oversampling factors are reduced with O₁=O₂=1, thereby reducing the number of precoders to 16 precoders. The codebook equation for the above examples is set forth in Equation 2.

$${W}_{{i}_{1 , 1} , {i}_{1 , 2} , {i}_{2}}^{( 1 )} = \frac{1}{\sqrt{8}} [ \begin{matrix}{v}_{{i}_{1 , 1} , {i}_{1 , 2}} \\ {φ}_{{i}_{2}} {v}_{{i}_{1 , 1} , {i}_{1 , 2}}\end{matrix} ] , \\ {i}_{1 , 1} = 0 , … , {N}_{1} {O}_{1} - 1 , {i}_{1 , 2} = 0 , … , {N}_{2} {O}_{2} - 1 , \\ {i}_{2} ∈ \{ 0 , 1 , 2 , 3 \} \qquad EQUATION 2$$

One example uses, as a starting point for an 8Tx, Rank 2, UL codebook for a UPA antenna structure, an NR DL codebook for UPA (N1=2,N2=2) XPOL layout, with mode=1, O₁=O₂=4, where N₁O₁×N₂O₂ (the number of co-phasing values (i₂))=8×8×2=128 precoders. In some examples, to provide a precoding matrix with elements in {+1, −1, j, −j}, the oversampling factors are reduced with O₁=O₂=2, thereby reducing the number of precoders to 32 precoders. In some examples, to further reduce the TPMI size, the oversampling factors are reduced with O₁=O₂=1, thereby reducing the number of precoders to 8 precoders. The codebook equation for this scenario is set forth in Equation 2. The codebook equation for the above examples is set forth in Equation 3.

$${W}_{{i}_{1 , 1} {i}_{1 , 1} , {i}_{1 , 2} , {i}_{1 , 2} , {i}_{2}}^{( 2 )} = \frac{1}{\sqrt{16}} [ \begin{matrix}{ν}_{{i}_{1 , 1} , {i}_{1 , 2}} & {ν}_{{i}_{1 , 1} , {i}_{1 , 2}} \\ {φ}_{{i}_{2}} {ν}_{{i}_{1 , 1} , {i}_{1 , 2}} & - {φ}_{{i}_{2}} {ν}_{{i}_{1 , 1} , {i}_{1 , 2}}\end{matrix} ] , \\ {i}_{1 , 1} = 0 , … , {N}_{1} {O}_{1} - 1 , {i}_{1 , 2} = 0 , … , {N}_{2} {O}_{2} - 1 , {i}_{2} ∈ \{ 0 , 1 \} \qquad EQUATION 3$$

One example uses, as a starting point for an 8Tx, Rank 3, UL codebook for a UPA antenna structure, an NR DL codebook for UPA (N1=2,N2=2) XPOL layout, with mode=1, O₁=O₂=4, where N₁O₁×N₂O₂ (the number of co-phasing values (i₂))=8×8×2=128 precoders. In some examples, to provide a precoding matrix with elements in {+1, −1, j, −j}, the oversampling factors are reduced with O₁=O₂=2, thereby reducing the number of precoders to 32 precoders. In some examples, to further reduce the TPMI size, the oversampling factors are reduced with 01=02=1, thereby reducing the number of precoders to 8 precoders. The codebook equation for the above examples is set forth in Equation 4.

$${W}_{{i}_{1 , 1} {i}_{1 , 1} + {O}_{1} , {i}_{1 , 2} , {i}_{1 , 2} , {i}_{2}}^{( 3 )} = \frac{1}{\sqrt{24}} [ \begin{matrix}{ν}_{{i}_{1 , 1} , {i}_{1 , 2}} & {ν}_{{i}_{1 , 1} + {O}_{1} , {i}_{1 , 2}} & {ν}_{{i}_{1 , 1} , {i}_{1 , 2}} \\ {φ}_{{i}_{2}} {ν}_{{i}_{1 , 1} , {i}_{1 , 2}} & {φ}_{{i}_{2}} {ν}_{{i}_{1 , 1} + {O}_{1} , {i}_{1 , 2}} & - {φ}_{{i}_{2}} {ν}_{{i}_{1 , 1} , {i}_{1 , 2}}\end{matrix} ] , \\ {i}_{1 , 1} = 0 , … , {N}_{1} {O}_{1} - 1 , {i}_{1 , 2} = 0 , … , {N}_{2} {O}_{2} - 1 , {i}_{2} ∈ \{ 0 , 1 \} \qquad EQUATION 4$$

One example uses, as a starting point for an 8Tx, Rank 4, UL codebook for a UPA antenna structure, an NR DL codebook for UPA (N1=2,N2=2) XPOL layout, with mode=1, O₁=O₂=4, where N₁O₁×N₂O₂ (the number of co-phasing values (i₂))=8×8×2=128 precoders. In some examples, to provide a precoding matrix with elements in {+1, −1, j, −j}, the oversampling factors are reduced with O₁=O₂=2, thereby reducing the number of precoders to 32 precoders. In some examples, to further reduce the TPMI size, the oversampling factors are reduced with O₁=O₂=1, thereby reducing the number of precoders to 8 precoders. The codebook equation for the above examples is set forth in Equation 5.

$${W}_{{i}_{1 , 1} {i}_{1 , 1} + {O}_{1} , {i}_{1 , 2} , {i}_{1 , 2} , {i}_{2}}^{( 4 )} = \frac{1}{\sqrt{32}} [ \begin{matrix}{ν}_{{i}_{1 , 1} , {i}_{1 , 2}} & {ν}_{{i}_{1 , 1} + {O}_{1} , {i}_{1 , 2}} & {ν}_{{i}_{1 , 1} , {i}_{1 , 2}} & {ν}_{{i}_{1 , 1} + {O}_{1} , {i}_{1 , 2}} \\ {φ}_{{i}_{2}} {ν}_{{i}_{1 , 1} , {i}_{1 , 2}} & {φ}_{{i}_{2}} {ν}_{{i}_{1 , 1} + {O}_{1} , {i}_{1 , 2}} & - {φ}_{{i}_{2}} {ν}_{{i}_{1 , 1} , {i}_{1 , 2}} & - {φ}_{{i}_{2}} {ν}_{{i}_{1 , 1} + {O}_{1} , {i}_{1 , 2}}\end{matrix} ] , \\ {i}_{1 , 1} = 0 , , {N}_{1} {O}_{1} - 1 , {i}_{1 , 2} = 0 , … , {N}_{2} {O}_{2} - 1 , {i}_{2} ∈ \{ 0 , 1 \} \qquad EQUATION 5$$

One example uses, as a starting point for an 8Tx, Rank 5, UL codebook for a UPA antenna structure, an NR DL codebook for UPA (N1=2,N2=2) XPOL layout, with mode=1, O₁=O₂=4, where N₁O₁×N₂O₂ (the number of co-phasing values (i₂))=8×8×2=128 precoders. In some examples, to provide a precoding matrix with elements in {+1, −1, j, −j}, the oversampling factors are reduced with O₁=O₂=2, thereby reducing the number of precoders to 32 precoders. In some examples, to further reduce the TPMI size, the oversampling factors are reduced with O₁=O₂=1, thereby reducing the number of precoders to 8 precoders. The codebook equation for the above examples is set forth in Equation 6.

$${W}_{{i}_{1 , 1} {i}_{1 , 1} + {O}_{1} , {i}_{1 , 1} + {O}_{1} , {i}_{1 , 2} , {i}_{1 , 2} , {i}_{1 , 2} + {O}_{2} {i}_{2}}^{( 5 )} = \frac{1}{\sqrt{40}} [ \begin{matrix}{ν}_{{i}_{1 , 1} , {i}_{1 , 2}} & {ν}_{{i}_{1 , 1} , {i}_{1 , 2}} & {ν}_{{i}_{1 , 1} + {O}_{1} , {i}_{1 , 2}} & {ν}_{{i}_{1 , 1} + {O}_{1} , {i}_{1 , 2}} & {v}_{{i}_{1 , 1} + {O}_{1} , {i}_{1 , 2} + {O}_{2}} \\ {φ}_{{i}_{2}} {ν}_{{i}_{1 , 1} , {i}_{1 , 2}} & - {φ}_{{i}_{2}} {ν}_{{i}_{1 , 1} , {i}_{1 , 2}} & {ν}_{{i}_{1 , 1} + {O}_{1} , {i}_{1 , 2}} & - {ν}_{{i}_{1 , 1} + {O}_{1} , {i}_{1 , 2}} & {v}_{{i}_{1 , 1} + {O}_{1} , {i}_{1 , 2} + {O}_{2}}\end{matrix} ] , \\ {i}_{1 , 1} = 0 , … , {N}_{1} {O}_{1} - 1 , {i}_{1 , 2} = 0 , … , {N}_{2} {O}_{2} - 1 , {i}_{2} ∈ \{ 0 , 1 \} \qquad EQUATION 6$$

One example uses, as a starting point for an 8Tx, Rank 6, UL codebook for a UPA antenna structure, an NR DL codebook for UPA (N₁₌₂,N₂₌₂) XPOL layout, with mode=1, O₁=O₂=4, where N₁O₁×N₂O₂ (the number of co-phasing values (i₂))=8×8×2=128 precoders. In some examples, to provide a precoding matrix with elements in {+1, −1, j, −j}, the oversampling factors are reduced with O₁=O₂=2, thereby reducing the number of precoders to 32 precoders. In some examples, to further reduce the TPMI size, the oversampling factors are reduced with O₁=O₂=1, thereby reducing the number of precoders to 8 precoders. The codebook equation for the above examples is set forth in Equation 7.

$${W}_{{i}_{1 , 1} {i}_{1 , 1} + {O}_{1} , {i}_{1 , 1} + {O}_{1} , {i}_{1 , 2} , {i}_{1 , 2} , {i}_{1 , 2} + {O}_{2} {i}_{2}}^{( 6 )} = \frac{1}{\sqrt{48}} [ \begin{matrix}{ν}_{{i}_{1 , 1} , {i}_{1 , 2}} & {ν}_{{i}_{1 , 1} , {i}_{1 , 2}} & {ν}_{{i}_{1 , 1} + {O}_{1} , {i}_{1 , 2}} & {ν}_{{i}_{1 , 1} + {O}_{1} , {i}_{1 , 2}} & {v}_{{i}_{1 , 1} + {O}_{1} , {i}_{1 , 2} + {O}_{2}} & {v}_{{i}_{1 , 1} + {O}_{1} , {i}_{1 , 2} + {O}_{2}} \\ {φ}_{{i}_{2}} {ν}_{{i}_{1 , 1} , {i}_{1 , 2}} & - {φ}_{{i}_{2}} {ν}_{{i}_{1 , 1} , {i}_{1 , 2}} & {φ}_{{i}_{2}} {ν}_{{i}_{1 , 1} + {O}_{1} , {i}_{1 , 2}} & - {φ}_{{i}_{2}} {ν}_{{i}_{1 , 1} + {O}_{1} , {i}_{1 , 2}} & {v}_{{i}_{1 , 1} + {O}_{1} , {i}_{1 , 2} + {O}_{2}} & - {v}_{{i}_{1 , 1} + {O}_{1} , {i}_{1 , 2} + {O}_{2}}\end{matrix} ] , \\ {i}_{1 , 1} = 0 , … , {N}_{1} {O}_{1} - 1 , {i}_{1 , 2} = 0 , … , {N}_{2} {O}_{2} - 1 , {i}_{2} ∈ \{ 0 , 1 \} \qquad EQUATION 7$$

One example uses, as a starting point for an 8Tx, Rank 7, UL codebook for a UPA antenna structure, an NR DL codebook for UPA (N1=2,N2=2) XPOL layout, with mode=1, O₁=O₂=4, where N₁O₁×N₂O₂ (the number of co-phasing values (i₂))=8×8×2=128 precoders. In some examples, to provide a precoding matrix with elements in {+1, −1, j, −j}, the oversampling factors are reduced with O₁=O₂=2, thereby reducing the number of precoders to 32 precoders. In some examples, to further reduce the TPMI size, the oversampling factors are reduced with O₁=O₂=1, thereby reducing the number of precoders to 8 precoders. The codebook equation for the above examples is set forth in Equation 8.

$${W}_{{i}_{1 , 1} {i}_{1 , 1} + {O}_{1} , {i}_{1 , 1} {i}_{1 , 1} + {O}_{1} , {i}_{1 , 2} , {i}_{1 , 2} , {i}_{1 , 2} + {O}_{2} {i}_{1 , 2} + {O}_{2} , {i}_{2}}^{( 7 )} = \frac{1}{\sqrt{56}} [ \begin{matrix}\begin{matrix}{ν}_{{i}_{1 , 1} , {i}_{1 , 2}} & {ν}_{{i}_{1 , 1} , {i}_{1 , 2}} & {ν}_{{i}_{1 , 1} + {O}_{1} , {i}_{1 , 2}} & {ν}_{{i}_{1 , 1} , {i}_{1 , 2} + {O}_{2}}\end{matrix} \\ \begin{matrix}{ν}_{{i}_{1 , 1} , {i}_{1 , 2} + {O}_{2}} & {ν}_{{i}_{1 , 1} + {O}_{1} , {i}_{1 , 2} + {O}_{2}} & {ν}_{{i}_{1 , 1} + {O}_{1} , {i}_{1 , 2} + {O}_{2}}\end{matrix}\end{matrix} … \begin{matrix}\begin{matrix}{φ}_{{i}_{2}} {ν}_{{i}_{1 , 1} , {i}_{1 , 2}} & - {φ}_{{i}_{2}} {ν}_{{i}_{1 , 1} , {i}_{1 , 2}} & {φ}_{{i}_{2}} {ν}_{{i}_{1 , 1} + {O}_{1} , {i}_{1 , 2}} & {ν}_{{i}_{1 , 1} , {i}_{1 , 2} + {O}_{2}}\end{matrix} \\ \begin{matrix}- {ν}_{{i}_{1 , 1} , {i}_{1 , 2} + {O}_{2}} & {ν}_{{i}_{1 , 1} + {O}_{1} , {i}_{1 , 2} + {O}_{2}} & - {ν}_{{i}_{1 , 1} + {O}_{1} , {i}_{1 , 2} + {O}_{2}}\end{matrix}\end{matrix} ] , \\ {i}_{1 , 1} = 0 , … , {N}_{1} {O}_{1} - 1 , {i}_{1 , 2} = 0 , … , {N}_{2} {O}_{2} - 1 , {i}_{2} ∈ \{ 0 , 1 \} \qquad EQUATION 8$$

One example uses, as a starting point for an 8Tx, Rank 8, UL codebook for a UPA antenna structure, an NR DL codebook for UPA (N1=2,N2=2) XPOL layout, with mode=1, O₁=O₂=4, where N₁O₁×N₂O₂ (the number of co-phasing values (i₂))=8×8×2=128 precoders. In some examples, to provide a precoding matrix with elements in {+1, −1, j, −j}, the oversampling factors are reduced with O₁=O₂=2, thereby reducing the number of precoders to 32 precoders. In some examples, to further reduce the TPMI size, the oversampling factors are reduced with O₁=O₂=1, thereby reducing the number of precoders to 8 precoders. The codebook equation for the above examples is set forth in Equation 9.

$${W}_{{i}_{1 , 1} {i}_{1 , 1} + {O}_{1} , {i}_{1 , 1} {i}_{1 , 1} + {O}_{1} , {i}_{1 , 2} , {i}_{1 , 2} , {i}_{1 , 2} + {O}_{2} {i}_{1 , 2} + {O}_{2} , {i}_{2}}^{( 8 )} = \frac{1}{\sqrt{64}} [ \begin{matrix}\begin{matrix}{ν}_{{i}_{1 , 1} , {i}_{1 , 2}} & {ν}_{{i}_{1 , 1} , {i}_{1 , 2}} & {ν}_{{i}_{1 , 1} + {O}_{1} , {i}_{1 , 2}} & {ν}_{{i}_{1 , 1} , {i}_{1 , 2} + {O}_{2}}\end{matrix} \\ \begin{matrix}{ν}_{{i}_{1 , 1} , {i}_{1 , 2} + {O}_{2}} & {ν}_{{i}_{1 , 1} + {O}_{1} , {i}_{1 , 2} + {O}_{2}} & {ν}_{{i}_{1 , 1} + {O}_{1} , {i}_{1 , 2} + {O}_{2}}\end{matrix}\end{matrix} … \begin{matrix}\begin{matrix}{φ}_{{i}_{2}} {ν}_{{i}_{1 , 1} , {i}_{1 , 2}} & - {φ}_{{i}_{2}} {ν}_{{i}_{1 , 1} , {i}_{1 , 2}} & {φ}_{{i}_{2}} {ν}_{{i}_{1 , 1} + {O}_{1} , {i}_{1 , 2}} & {ν}_{{i}_{1 , 1} , {i}_{1 , 2} + {O}_{2}}\end{matrix} \\ \begin{matrix}- {ν}_{{i}_{1 , 1} , {i}_{1 , 2} + {O}_{2}} & {ν}_{{i}_{1 , 1} + {O}_{1} , {i}_{1 , 2} + {O}_{2}} & - {ν}_{{i}_{1 , 1} + {O}_{1} , {i}_{1 , 2} + {O}_{2}}\end{matrix}\end{matrix} ] , \\ {i}_{1 , 1} = 0 , … , {N}_{1} {O}_{1} - 1 , {i}_{1 , 2} = 0 , … , {N}_{2} {O}_{2} - 1 , {i}_{2} ∈ \{ 0 , 1 \} \qquad EQUATION 9$$

Several examples of eight element (8Tx) uplink codebooks for the 4×1 uniform linear array (ULA) 1204 layout illustrated in FIG. 12 follow. The ULA 1204 include cross-pole antenna elements (e.g., antenna elements 0 and 4 have different polarizations) such that the total number of antenna elements is eight (8).

One example uses, as a starting point for an 8Tx, Rank 1, UL codebook for a ULA antenna structure, an NR DL codebook for ULA (N1=4,N2=1) XPOL layout, O₁=4, where N₁O₁×(the number of co-phasing values (i₂))=16×4=64 precoders. In some examples, to provide a precoding matrix with elements in {+1, −1, j, −j}, the oversampling factors are reduced with O₁=1, thereby reducing the number of precoders to 16 precoders. The codebook equation for the above examples is set forth in Equation 10.

$${W}_{{i}_{1 , 1} , 0 , {i}_{2}}^{( 1 )} = \frac{1}{\sqrt{8}} [ \begin{matrix}{ν}_{{i}_{1 , 1} , 0} \\ {φ}_{{i}_{2}} {ν}_{{i}_{1 , 1} , 0}\end{matrix} ] , \\ {i}_{1 , 1} = 0 , … , {N}_{1} {O}_{1} - 1 , {i}_{2} ∈ \{ 0 , 1 , 2 , 3 \} \qquad EQUATION 10$$

One example uses, as a starting point for an 8Tx, Rank 2, UL codebook for a ULA antenna structure, an NR DL codebook for ULA (N1=4,N2=1) XPOL layout, O₁=4, where N₁O₁×(the number of co-phasing values (i₂))=16×2=32 precoders. In some examples, to provide a precoding matrix with elements in {+1, −1, j, −j}, the oversampling factors are reduced with O₁=1, thereby reducing the number of precoders to 8 precoders. The codebook equation for the above examples is set forth in Equation 11.

$${W}_{{i}_{1 , 1} {i}_{1 , 1} , 0 , 0 , {i}_{2}}^{( 2 )} = \frac{1}{\sqrt{16}} [ \begin{matrix}{ν}_{{i}_{1 , 1} , 0} & {v}_{{i}_{1 , 1} , 0} \\ {φ}_{{i}_{2}} {ν}_{{i}_{1 , 1} , 0} & - {φ}_{{i}_{2}} {ν}_{{i}_{1 , 1} , 0}\end{matrix} ] , \\ {i}_{1 , 1} = 0 , … , {N}_{1} {O}_{1} - 1 , {i}_{2} ∈ \{ 0 , 1 \} \qquad EQUATION 11$$

One example uses, as a starting point for an 8Tx, Rank 3, UL codebook for a ULA antenna structure, an NR DL codebook for ULA (N1=4,N2=1) XPOL layout, O₁=4, where N₁O₁×(the number of co-phasing values (i₂))=16×2=32 precoders. In some examples, to provide a precoding matrix with elements in {+1, −1, j, −j}, the oversampling factors are reduced with O₁=1, thereby reducing the number of precoders to 8 precoders. The codebook equation for the above examples is set forth in Equation 12.

$${W}_{{i}_{1 , 1} {i}_{1 , 1} + {O}_{1} , 0 , 0 , {i}_{2}}^{( 3 )} = \frac{1}{\sqrt{24}} [ \begin{matrix}{ν}_{{i}_{1 , 1} , 0} & {ν}_{{i}_{1 , 1} + {O}_{1} , 0} & {ν}_{{i}_{1 , 1} , 0} \\ {φ}_{{i}_{2}} {ν}_{{i}_{1 , 1} , 0} & {φ}_{{i}_{2}} {ν}_{{i}_{1 , 1} + {O}_{1} , 0} & - {φ}_{{i}_{2}} {ν}_{{i}_{1 , 1} , 0}\end{matrix} ] , \\ {i}_{1 , 1} = 0 , … , {N}_{1} {O}_{1} - 1 , 0 , {i}_{2} ∈ \{ 0 , 1 \} \qquad EQUATION 12$$

One example uses, as a starting point for an 8Tx, Rank 4, UL codebook for a ULA antenna structure, an NR DL codebook for ULA (N1=4,N2=1) XPOL layout, O₁=4, where N₁O₁×(the number of co-phasing values (i₂))=16×2=32 precoders. In some examples, to provide a precoding matrix with elements in {+1, −1, j, −j}, the oversampling factors are reduced with O₁=1, thereby reducing the number of precoders to 8 precoders. The codebook equation for the above examples is set forth in Equation 13.

$${W}_{{i}_{1 , 1} {i}_{1 , 1} + {O}_{1} , 0 , 0 , {i}_{2}}^{( 4 )} = \frac{1}{\sqrt{32}} [ \begin{matrix}{ν}_{{i}_{1 , 1} , 0} & {ν}_{{i}_{1 , 1} + {O}_{1} , 0} & {ν}_{{i}_{1 , 1} , 0} & {ν}_{{i}_{1 , 1} + {O}_{1} , 0} \\ {φ}_{{i}_{2}} {ν}_{{i}_{1 , 1} , 0} & {φ}_{{i}_{2}} {ν}_{{i}_{1 , 1} + {O}_{1} , 0} & - {φ}_{{i}_{2}} {ν}_{{i}_{1 , 1} , 0} & - {φ}_{{i}_{2}} {ν}_{{i}_{1 , 1} + {O}_{1} , 0}\end{matrix} ] , \\ {i}_{1 , 1} = 0 , … , {N}_{1} {O}_{1} - 1 , {i}_{2} ∈ \{ 0 , 1 \} \qquad EQUATION 13$$

One example uses, as a starting point for an 8Tx, Rank 5, UL codebook for a ULA antenna structure, an NR DL codebook for ULA (N1=4,N2=1) XPOL layout, O₁=4, where N₁O₁×(the number of co-phasing values (i₂))=16×2=32 precoders. In some examples, to provide a precoding matrix with elements in {+1, −1, j, −j}, the oversampling factors are reduced with O₁=1, thereby reducing the number of precoders to 8 precoders. The codebook equation for the above examples is set forth in Equation 14.

$${W}_{{i}_{1 , 1} {i}_{1 , 1} + {O}_{1} , {i}_{1 , 1} + 2 {O}_{1} , 0 , 0 , 0 , {i}_{2}}^{( 5 )} = \frac{1}{\sqrt{40}} [ \begin{matrix}{ν}_{{i}_{1 , 1} , 0} & {ν}_{{i}_{1 , 1} , 0} & {ν}_{{i}_{1 , 1} + {O}_{1} , 0} & {ν}_{{i}_{1 , 1} + {O}_{1} , 0} & {v}_{{i}_{1 , 1} + 2 {O}_{1} , 0} \\ {φ}_{{i}_{2}} {ν}_{{i}_{1 , 1} , 0} & - {φ}_{{i}_{2}} {ν}_{{i}_{1 , 1} , 0} & {ν}_{{i}_{1 , 1} + {O}_{1} , 0} & - {ν}_{{i}_{1 , 1} + {O}_{1} , 0} & {v}_{{i}_{1 , 1} + 2 {O}_{1} , 0}\end{matrix} ] , \\ {i}_{1 , 1} = 0 , … , {N}_{1} {O}_{1} - 1 , {i}_{2} ∈ \{ 0 , 1 \} \qquad EQUATION 14$$

One example uses, as a starting point for an 8Tx, Rank 6, UL codebook for a ULA antenna structure, an NR DL codebook for ULA (N1=4,N2=1) XPOL layout, O₁=4, where N₁O₁×(the number of co-phasing values (i₂))=16×2=32 precoders. In some examples, to provide a precoding matrix with elements in {+1, −1, j, −j}, the oversampling factors are reduced with O₁=1, thereby reducing the number of precoders to 8 precoders. The codebook equation for the above examples is set forth in Equation 15.

$${W}_{{i}_{1 , 1} {i}_{1 , 1} + {O}_{1} , {i}_{1 , 1} + 2 {O}_{1} , 0 , 0 , 0 , {i}_{2}}^{( 6 )} = \frac{1}{\sqrt{48}} [ \begin{matrix}{ν}_{{i}_{1 , 1} , 0} & {ν}_{{i}_{1 , 1} , 0} & {ν}_{{i}_{1 , 1} + {O}_{1} , 0} & {ν}_{{i}_{1 , 1} + {O}_{1} , 0} & {ν}_{{i}_{1 , 1} + 2 {O}_{1} , 0} & {ν}_{{i}_{1 , 1} + 2 {O}_{1} , 0} \\ {φ}_{{i}_{2}} {ν}_{{i}_{1 , 1} , 0} & - {φ}_{{i}_{2}} {ν}_{{i}_{1 , 1} , 0} & {φ}_{{i}_{2}} {ν}_{{i}_{1 , 1} + {O}_{1} , 0} & - {φ}_{{i}_{2}} {ν}_{{i}_{1 , 1} + {O}_{1} , 0} & {ν}_{{i}_{1 , 1} + 2 {O}_{1} , 0} & - {ν}_{{i}_{1 , 1} + 2 {O}_{1} , 0}\end{matrix} ] , \\ {i}_{1 , 1} = 0 , … , {N}_{1} {O}_{1} - 1 , {i}_{2} ∈ \{ 0 , 1 \} \qquad EQUATION 15$$

One example uses, as a starting point for an 8Tx, Rank 7, UL codebook for a ULA antenna structure, an NR DL codebook for ULA (N1=4,N2=1) XPOL layout, O₁=4, where N₁O₁/2×(the number of co-phasing values (i₂))=8×2=16 precoders. In some examples, to provide a precoding matrix with elements in {+1, −1, j, −j}, the oversampling factors are reduced with O₁=1, thereby reducing the number of precoders to 4 precoders. The codebook equation for the above examples is set forth in Equation 16.

$${W}_{{i}_{1 , 1} , {i}_{1 , 1} + {O}_{1} , {i}_{1 , 1} + 2 {O}_{1} , {i}_{1 , 1} + 3 {O}_{{1}_{1 , 2}} , 0 , 0 , 0 , 0 , {i}_{2}}^{( 7 )} = \frac{1}{\sqrt{56}} [ \begin{matrix}{ν}_{{i}_{1 , 1} , 0} & {ν}_{{i}_{1 , 1} , 0} & {ν}_{{i}_{1 , 1} + {O}_{1} , 0} & {ν}_{{i}_{1 , 1 + 2 {O}_{1} , 0}} & {ν}_{{i}_{1 , 1 + 2 {O}_{1} , 0}} & {ν}_{{i}_{1 , 1 + 3 {O}_{1} , 0}} & {ν}_{{i}_{1 , 1 + 3 {O}_{1} , 0}} \\ {φ}_{{i}_{2}} {ν}_{{i}_{1 , 1} , 0} & - {φ}_{{i}_{2}} {ν}_{{i}_{1 , 1} , 0} & {φ}_{{i}_{2}} {ν}_{{i}_{1 , 1} + {O}_{1} , 0} & {ν}_{{i}_{1 , 1} + 2 O , 0} & - {ν}_{{i}_{1 , 1} + 2 O , 0} & {ν}_{{i}_{1 , 1} + 3 O , 0} & - {ν}_{{i}_{1 , 1} + 3 O , 0}\end{matrix} ] , \\ {i}_{1 , 1} = 0 , … , {N}_{1} {O}_{1} / 2 - 1 , {i}_{2} ∈ \{ 0 , 1 \} \qquad EQUATION 16$$

One example uses, as a starting point for an 8Tx, Rank 8, UL codebook for a ULA antenna structure, an NR DL codebook for ULA (N1=4,N2=1) XPOL layout, O₁=4, where N₁O₁/2×(the number of co-phasing values (i₂))=8×2=16 precoders. In some examples, to provide a precoding matrix with elements in {+1, −1, j, −j}, the oversampling factors are reduced with O₁=1, thereby reducing the number of precoders to 4 precoders. The codebook equation for the above examples is set forth in Equation 17.

$${W}_{{i}_{1 , 1} , {i}_{1 , 1} + {O}_{1} , {i}_{1 , 1} + 2 {O}_{1} , {i}_{1 , 1} + 3 {O}_{{1}_{1 , 2}} , 0 , 0 , 0 , 0 , {i}_{2}}^{( 8 )} = \frac{1}{\sqrt{64}} [ \begin{matrix}{ν}_{{i}_{1 , 1} , 0} & {ν}_{{i}_{1 , 1} , 0} & {ν}_{{i}_{1 , 1} + {O}_{1} , 0} & {ν}_{{i}_{1 , 1} + {O}_{1} , 0} \\ {ν}_{{i}_{1 , 1} + 2 {O}_{1} , 0} & {ν}_{{i}_{1 , 1} + 2 {O}_{1} , 0} & {ν}_{{i}_{1 , 1 + 3 {O}_{1} , 0}} & {ν}_{{i}_{1 , 1 + 3 {O}_{1} , 0}}\end{matrix} … \begin{matrix}{φ}_{{i}_{2}} {ν}_{{i}_{1 , 1} , 0} & - {φ}_{{i}_{2}} {ν}_{{i}_{1 , 1} , 0} & {φ}_{{i}_{2}} {ν}_{{i}_{1 , 1} + {O}_{1} , 0} & - {φ}_{{i}_{2}} {ν}_{{i}_{1 , 1} + {O}_{1} , 0} \\ {ν}_{{i}_{1 , 1 + 2 {O}_{1} , 0}} & - {ν}_{{i}_{1 , 1 + 2 {O}_{1} , 0}} & {ν}_{{i}_{1 , 1 + 3 {O}_{1} , 0}} & - {ν}_{{i}_{1 , 1 + 3 {O}_{1} , 0}}\end{matrix} ] , \\ {i}_{1 , 1} = 0 , … , {N}_{1} {O}_{1} / 2 - 1 , {i}_{2} ∈ \{ 0 , 1 \} \qquad EQUATION 17$$

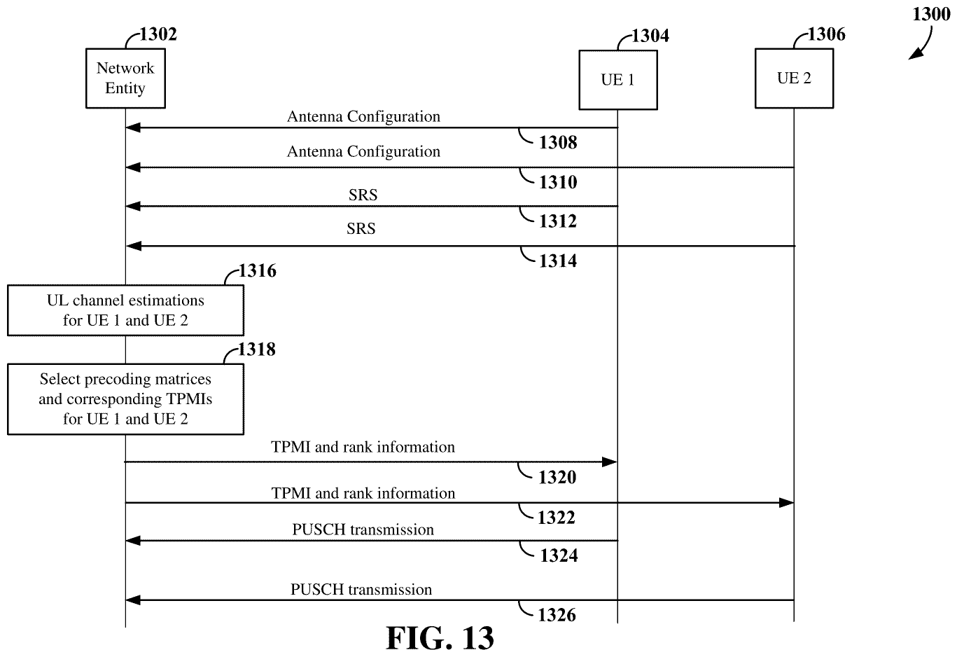

FIG. 13 is a signaling diagram 1300 illustrating an example of signaling associated with communication of codebook-related information in a wireless communication system including a network entity 1302, a first user equipment 1304, and a second user equipment 1306. In some examples, the network entity 1302 may correspond to any of the network entities, base stations, CUs, DUs, RUs, or scheduling entities shown in any of FIGS. 1, 2, 3, 5, and 18. In some examples, the first user equipment 1304 and the second user equipment 1306 may correspond to any of the UEs or scheduled entities shown in any of FIGS. 1, 2, 3, 5, and 14.

At 1308 of FIG. 13, the first user equipment 1304 sends an indication of its antenna configuration to the network entity 1302 (e.g., via a UE capabilities message). For example, the first user equipment 1304 may indicate that it employs a 2×2 UPA or some other antenna configuration.

At 1310, the second user equipment 1306 sends an indication of its antenna configuration to the network entity 1302 (e.g., via a UE capabilities message). For example, the second user equipment 1306 may indicate that it employs a 4×1 ULA or some other antenna configuration.

At 1312, the first user equipment 1304 transmits sounding reference signals to the network entity 1302 via one or more antenna ports (e.g., via SRS resources configured by the network entity 1302). Similarly, at 1314, the second user equipment 1306 transmits sounding reference signals to the network entity 1302 via one or more antenna ports (e.g., via SRS resources configured by the network entity 1302).

At 1316, the network entity 1302 estimates the uplink channel from the first user equipment 1304 to the network entity 1302 based on the sounding reference signals received at 1312. Similarly, at 1318, the network entity 1302 estimates the uplink channel from the second user equipment 1306 to the network entity 1302 based on the sounding reference signals received at 1314.

At 1318, the network entity 1302 selects a precoding matrix within an uplink codebook for an uplink transmission by the first user equipment 1304. As discussed herein, the selection of the precoding matrix may be based on antenna configuration of the first user equipment 1304 (e.g., based on the indication received at 1308). In addition, in some examples, the corresponding codebook may be generated based on a lower value for at least one oversampling factor as compared to the oversampling factor(s) for a downlink transmission using the same antenna configuration.

The network entity 1302 also selects a precoding matrix within an uplink codebook for an uplink transmission by the second user equipment 1306. The selection of the precoding matrix may be based on antenna configuration of the second user equipment 1306 (e.g., based on the indication received at 1310). In addition, in some examples, the corresponding codebook may be generated based on a lower value for at least one oversampling factor as compared to the oversampling factor(s) for a downlink transmission using the same antenna configuration.

At 1320, the network entity 1302 transmits control signaling to the first user equipment 1304, where the control signaling indicates the corresponding TPMI selected at 1318 and associated rank information for the uplink transmission. For example, the network entity may transmit a DCI 0_1 that includes a TPMI field to the first user equipment 1304 to schedule a PDSCH transmission.

At 1322, the network entity 1302 transmits control signaling to the second user equipment 1306, where the control signaling indicates the corresponding TPMI selected at 1318 and associated rank information for this uplink transmission. For example, the network entity may transmit a DCI 0_1 that includes a TPMI field to the second user equipment 1306 to schedule a PDSCH transmission.

At 1324, the first user equipment 1304 transmits a physical uplink shared channel transmission to the network entity 1302 using the TPMI and rank information received at 1320. For example, using the TPMI received at 1320, the first user equipment 1304 may identify the precoder to be used for a PUSCH transmission from a configured codebook.

At 1326, the second user equipment 1306 transmits a physical uplink shared channel transmission to the network entity 1302 using the TPMI and rank information received at 1322. For example, using the TPMI received at 1322, the first user equipment 1304 may identify the precoder to be used for a PUSCH transmission from a configured codebook.

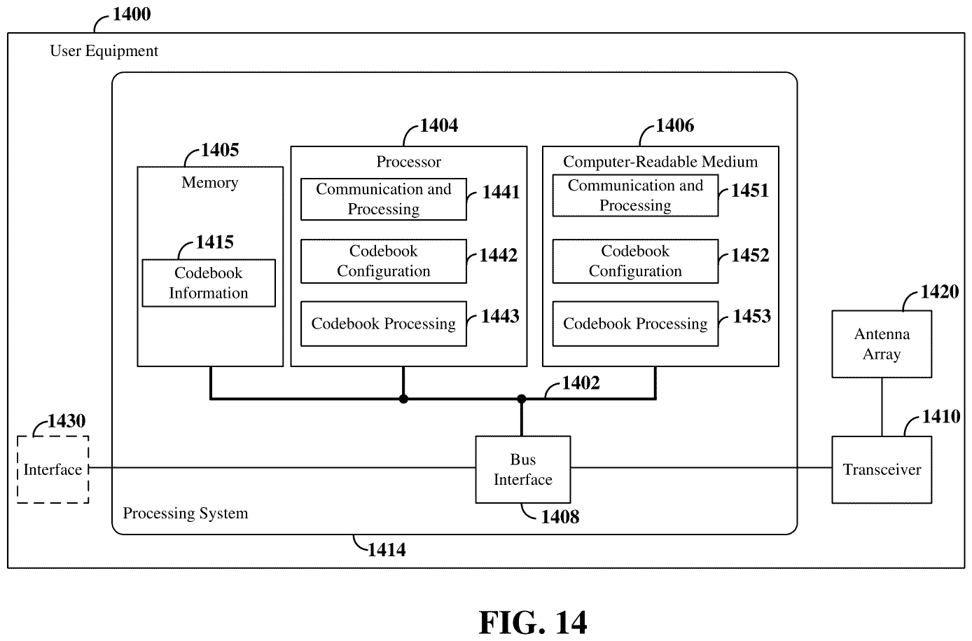

FIG. 14 is a block diagram illustrating an example of a hardware implementation for a UE 1400 employing a processing system 1414. For example, the UE 1400 may be a device configured to wirelessly communicate with a network entity, as discussed in any one or more of FIGS. 1-13. In some implementations, the UE 1400 may correspond to any of the UEs or scheduled entities shown in any of FIGS. 1, 2, 3, 8, and 13.

In accordance with various aspects of the disclosure, an element, or any portion of an element, or any combination of elements may be implemented with the processing system 1414. The processing system 1414 may include one or more processors 1404. Examples of processors 1404 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the UE 1400 may be configured to perform any one or more of the functions described herein. That is, the processor 1404, as utilized in a UE 1400, may be used to implement any one or more of the processes and procedures described herein.

The processor 1404 may in some instances be implemented via a baseband or modem chip and in other implementations, the processor 1404 may include a number of devices distinct and different from a baseband or modem chip (e.g., in such scenarios as may work in concert to achieve the examples discussed herein). And as mentioned above, various hardware arrangements and components outside of a baseband modem processor can be used in implementations, including RF-chains, power amplifiers, modulators, buffers, interleavers, adders/summers, etc.

In this example, the processing system 1414 may be implemented with a bus architecture, represented generally by the bus 1402. The bus 1402 may include any number of interconnecting buses and bridges depending on the specific application of the processing system 1414 and the overall design constraints. The bus 1402 communicatively couples together various circuits including one or more processors (represented generally by the processor 1404), a memory 1405, and computer-readable media (represented generally by the computer-readable medium 1406). The bus 1402 may also link various other circuits such as timing sources, peripherals, voltage regulators, and power management circuits, which are well known in the art, and therefore, will not be described any further. A bus interface 1408 provides an interface between the bus 1402, a transceiver 1410 and an antenna array 1420 and between the bus 1402 and an interface 1430. The transceiver 1410 provides a communication interface or means for communicating with various other apparatus over a wireless transmission medium. The interface 1430 provides a communication interface or means of communicating with various other apparatuses and devices (e.g., other devices housed within the same apparatus as the UE 1400 or other external apparatuses) over an internal bus or external transmission medium, such as an Ethernet cable. Depending upon the nature of the apparatus, the interface 1430 may include a user interface (e.g., keypad, display, speaker, microphone, joystick). Of course, such a user interface is optional, and may be omitted in some examples, such as an IoT device.

The processor 1404 is responsible for managing the bus 1402 and general processing, including the execution of software stored on the computer-readable medium 1406. The software, when executed by the processor 1404, causes the processing system 1414 to perform the various functions described below for any particular apparatus. The computer-readable medium 1406 and the memory 1405 may also be used for storing data that is manipulated by the processor 1404 when executing software. For example, the memory 1405 may store codebook information 1415 (e.g., precoders) used by the processor 1404 for the communication operations described herein.

One or more processors 1404 in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium 1406.

The computer-readable medium 1406 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 1406 may reside in the processing system 1414, external to the processing system 1414, or distributed across multiple entities including the processing system 1414. The computer-readable medium 1406 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

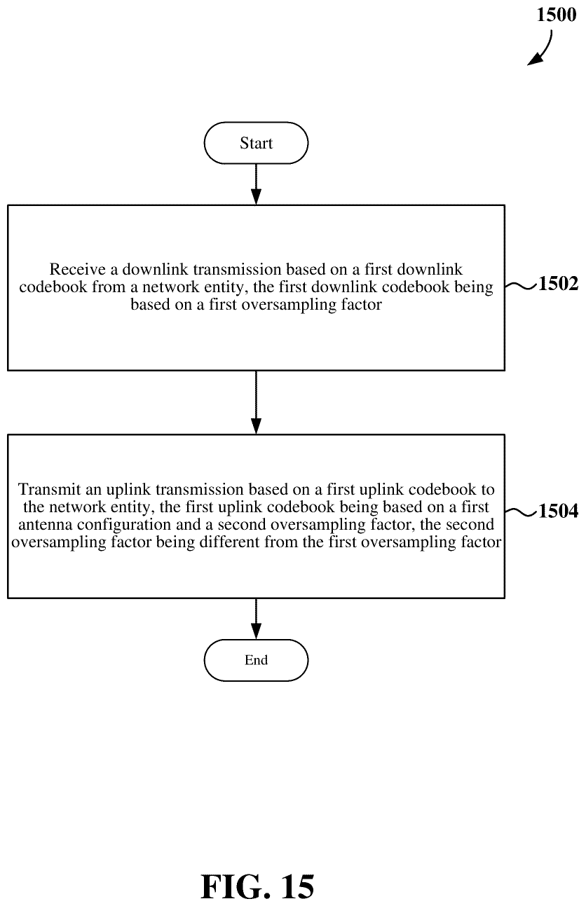

The UE 1400 may be configured to perform any one or more of the operations described herein (e.g., as described above in conjunction with FIGS. 1-13 and as described below in conjunction with FIGS. 15-17). In some aspects of the disclosure, the processor 1404, as utilized in the UE 1400, may include circuitry configured for various functions.

The processor 1404 may include communication and processing circuitry 1441. The communication and processing circuitry 1441 may be configured to communicate with a network entity, such as a gNB. The communication and processing circuitry 1441 may be configured to communicate with a network entity and one or more other wireless communication devices over a common carrier shared between a cellular (e.g., Uu) interface and a sidelink (e.g., PC5) interface. The communication and processing circuitry 1441 may include one or more hardware components that provide the physical structure that performs various processes related to wireless communication (e.g., signal reception and/or signal transmission) as described herein. The communication and processing circuitry 1441 may further include one or more hardware components that provide the physical structure that performs various processes related to signal processing (e.g., processing a received signal and/or processing a signal for transmission) as described herein. In some examples, the communication and processing circuitry 1441 may include two or more transmit/receive chains (e.g., one chain to communicate with a network entity and another chain to communicate with a sidelink device). The communication and processing circuitry 1441 may further be configured to execute communication and processing software 1451 included on the computer-readable medium 1406 to implement one or more functions described herein.

In some implementations where the communication involves receiving information, the communication and processing circuitry 1441 may obtain information from a component of the UE 1400 (e.g., from the transceiver 1410 that receives the information via radio frequency signaling or some other type of signaling suitable for the applicable communication medium), process (e.g., decode) the information, and output the processed information. For example, the communication and processing circuitry 1441 may output the information to another component of the processor 1404, to the memory 1405, or to the bus interface 1408. In some examples, the communication and processing circuitry 1441 may receive one or more of signals, messages, other information, or any combination thereof. In some examples, the communication and processing circuitry 1441 may receive information via one or more channels. In some examples, the communication and processing circuitry 1441 may receive one or more of signals, messages, SCIs, feedback, other information, or any combination thereof. In some examples, the communication and processing circuitry 1441 may receive information via one or more of a PSCCH, a PSSCH, a PSFCH, some other type of channel, or any combination thereof. In some examples, the communication and processing circuitry 1441 may include functionality for a means for receiving. In some examples, the communication and processing circuitry 1441 may include functionality for a means for decoding. In some examples, the communication and processing circuitry 1441 and/or the transceiver 1410 may include functionality for a means for receiving a downlink transmission.

In some implementations where the communication involves sending (e.g., transmitting) information, the communication and processing circuitry 1441 may obtain information (e.g., from another component of the processor 1404, the memory 1405, or the bus interface 1408), process (e.g., encode) the information, and output the processed information. For example, the communication and processing circuitry 1441 may output the information to the transceiver 1410 (e.g., that transmits the information via radio frequency signaling or some other type of signaling suitable for the applicable communication medium). In some examples, the communication and processing circuitry 1441 may send one or more of signals, messages, other information, or any combination thereof. In some examples, the communication and processing circuitry 1441 may send information via one or more channels. In some examples, the communication and processing circuitry 1441 may send one or more of signals, messages, feedback, other information, or any combination thereof. In some examples, the communication and processing circuitry 1441 may send information via one or more of a PSCCH, a PSSCH, a PSFCH, some other type of channel, or any combination thereof. In some examples, the communication and processing circuitry 1441 may include functionality for a means for sending (e.g., a means for transmitting). In some examples, the communication and processing circuitry 1441 may include functionality for a means for encoding. In some examples, the communication and processing circuitry 1441 and/or the transceiver 1410 may include functionality for a means for transmitting an uplink transmission.

The processor 1404 may include codebook configuration circuitry 1442 configured to perform codebook configuration-related operations as discussed herein (e.g., one or more of the operations described above in conjunction with FIGS. 8-13). The codebook configuration circuitry 1442 may be configured to execute codebook configuration software 1452 included on the computer-readable medium 1406 to implement one or more functions described herein.

The codebook configuration circuitry 1442 may include functionality for a means for transmitting configuration information (e.g., as described above in conjunction with FIGS. 8-13). For example, the codebook configuration circuitry 1442 may transmit an RRC message including antenna configuration information to a network entity via a PUSCH.

The codebook configuration circuitry 1442 may include functionality for a means for receiving codebook information (e.g., as described above in conjunction with FIGS. 8-13). For example, the codebook configuration circuitry 1442 may receive an RRC message including codebook information from a network entity via a PDSCH. As another example, the codebook configuration circuitry 1442 may receive a DCI including a TPMI from a network entity via a PDCCH.

The processor 1404 may include codebook processing circuitry 1443 configured to perform codebook processing-related operations as discussed herein (e.g., one or more of the operations described above in conjunction with FIGS. 8-13). The codebook processing circuitry 1443 may be configured to execute codebook processing software 1453 included on the computer-readable medium 1406 to implement one or more functions described herein.

The codebook processing circuitry 1443 may include functionality for a means for transmitting an uplink transmission (e.g., as described above in conjunction with FIGS. 8-13). For example, the codebook processing circuitry 1443 may identify, from an uplink codebook, a precoder to be used for an uplink transmission to a network entity, where the identification of the precoder is based on a TPMI received from the network entity.

The codebook processing circuitry 1443 may include functionality for a means for receiving a downlink transmission (e.g., as described above in conjunction with FIGS. 8-13). For example, the codebook processing circuitry 1443 may receive a downlink transmission that was precoded using a downlink codebook.

FIG. 15 is a flow chart illustrating an example method 1500 for a user equipment in accordance with some aspects of the present disclosure. As described below, some or all illustrated features may be omitted in a particular implementation within the scope of the present disclosure, and some illustrated features may not be required for implementation of all examples. In some examples, the method 1500 (e.g., a method for wireless communication) may be carried out by the UE 1400 illustrated in FIG. 14. In some examples, the method 1500 may be carried out by any suitable apparatus or means for carrying out the functions or algorithm described below.

At block 1502, a user equipment may receive a downlink transmission based on a first downlink codebook from a network entity, the first downlink codebook being based on first oversampling factor. In some examples, the codebook processing circuitry 1443 together with the communication and processing circuitry 1441 and the transceiver 1410, shown and described in FIG. 14, may provide a means to receive a downlink transmission based on a first downlink codebook from a network entity, the first downlink codebook being based on a first oversampling factor.

At block 1504, the user equipment may transmit an uplink transmission based on a first uplink codebook to the network entity, the first uplink codebook being based on a first antenna configuration and a second oversampling factor, the second oversampling factor being different from the first oversampling factor. In some examples, the codebook processing circuitry 1443 together with the communication and processing circuitry 1441 and the transceiver 1410, shown and described in FIG. 14, may provide a means to transmit an uplink transmission based on a first uplink codebook to the network entity, the first uplink codebook being based on a first antenna configuration and a second oversampling factor, the second oversampling factor being different from the first oversampling factor.

In some examples, the user equipment may transmit a first indication of the first antenna configuration to the network entity. In some examples, the user equipment may receive a second indication of a codebook set including the first uplink codebook from the network entity, the codebook set being based on the first antenna configuration. In some examples, the first antenna configuration is an antenna configuration of the user equipment.

In some examples, the first antenna configuration may include a uniform planar array with eight antenna elements. In some examples, the first antenna configuration may include a uniform planar array including two antenna elements in a horizontal domain and two antenna elements in a vertical domain. In some examples, the first oversampling factor is a value of four. In some examples, the second oversampling factor is a value of two.

In some examples, the first antenna configuration may include a uniform planar array including two antenna elements in a horizontal domain and two antenna elements in a vertical domain. In some examples, the first oversampling factor is a value of four. In some examples, the second oversampling factor is a value of one.

In some examples, the first antenna configuration may include a uniform linear array with eight antenna elements. In some examples, the first antenna configuration may include a uniform linear array including four antenna elements in a horizontal domain and one antenna element in a vertical domain. In some examples, the first oversampling factor is a value of four. In some examples, the second oversampling factor is a value of one.

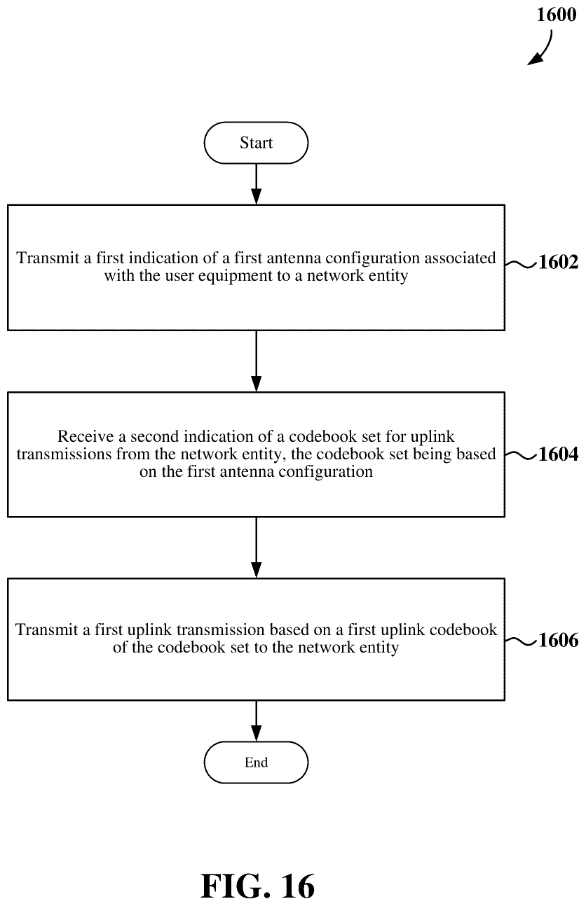

FIG. 16 is a flow chart illustrating an example method 1600 for a user equipment in accordance with some aspects of the present disclosure. As described below, some or all illustrated features may be omitted in a particular implementation within the scope of the present disclosure, and some illustrated features may not be required for implementation of all examples. In some examples, the method 1600 (e.g., a method for wireless communication) may be carried out by the UE 1400 illustrated in FIG. 14. In some examples, the method 1600 may be carried out by any suitable apparatus or means for carrying out the functions or algorithm described below.

At block 1602, a user equipment may transmit a first indication of a first antenna configuration associated with the user equipment to a network entity. In some examples, the codebook configuration circuitry 1442 together with the communication and processing circuitry 1441 and the transceiver 1410, shown and described in FIG. 14, may provide a means to transmit a first indication of a first antenna configuration associated with the user equipment to a network entity.

At block 1604, the user equipment may receive a second indication of a codebook set for uplink transmissions from the network entity, the codebook set being based on the first antenna configuration. In some examples, the codebook configuration circuitry 1442 together with the communication and processing circuitry 1441 and the transceiver 1410, shown and described in FIG. 14, may provide a means to receive a second indication of a codebook set for uplink transmissions from the network entity, the codebook set being based on the first antenna configuration.

At block 1606, the user equipment may transmit a first uplink transmission based on a first uplink codebook of the codebook set to the network entity. In some examples, the codebook processing circuitry 1443 together with the communication and processing circuitry 1441 and the transceiver 1410, shown and described in FIG. 14, may provide a means to transmit a first uplink transmission based on a first uplink codebook of the codebook set to the network entity.

In some examples, the first antenna configuration may include a uniform planar array with eight antenna elements. In some examples, the first antenna configuration may include a uniform planar array including two antenna elements in a horizontal domain and two antenna elements in a vertical domain. In some examples, the first uplink codebook is based on an oversampling factor value of two.

In some examples, the first antenna configuration may include a uniform planar array including two antenna elements in a horizontal domain and two antenna elements in a vertical domain. In some examples, the first uplink codebook is based on an oversampling factor value of one.

In some examples, the first antenna configuration may include a uniform linear array with eight antenna elements. In some examples, the first antenna configuration may include a uniform linear array including four antenna elements in a horizontal domain and one antenna element in a vertical domain. In some examples, the first uplink codebook is based on an oversampling factor value of one.

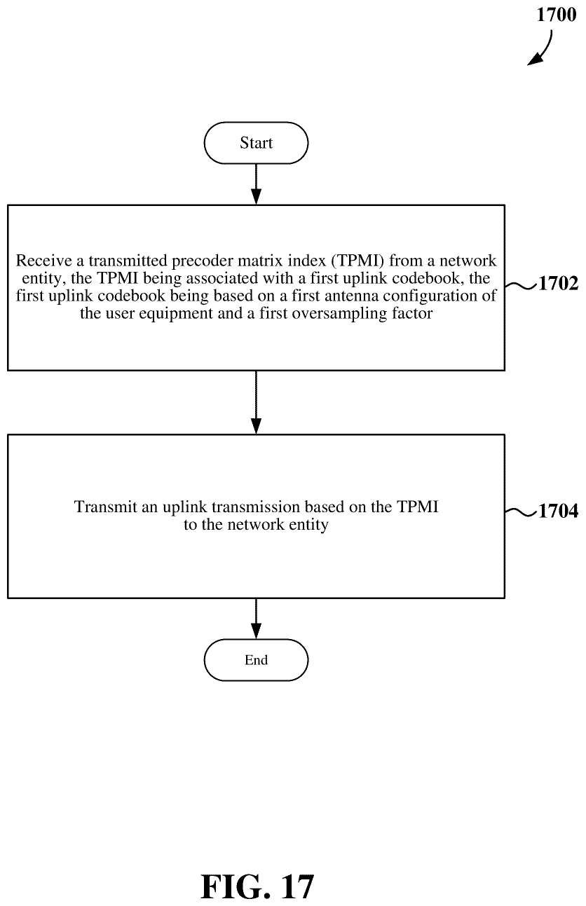

FIG. 17 is a flow chart illustrating an example method 1700 for a user equipment in accordance with some aspects of the present disclosure. As described below, some or all illustrated features may be omitted in a particular implementation within the scope of the present disclosure, and some illustrated features may not be required for implementation of all examples. In some examples, the method 1700 (e.g., a method for wireless communication) may be carried out by the UE 1400 illustrated in FIG. 14. In some examples, the method 1700 may be carried out by any suitable apparatus or means for carrying out the functions or algorithm described below.

At block 1702, a user equipment may receive a transmitted precoder matrix index (TPMI) from a network entity, the TPMI being associated with a first uplink codebook, the first uplink codebook being based on a first antenna configuration of the user equipment and a first oversampling factor. In some examples, the codebook processing circuitry 1443 together with the communication and processing circuitry 1441 and the transceiver 1410, shown and described in FIG. 14, may provide a means to receive a transmitted precoder matrix index (TPMI) from a network entity, the TPMI being associated with a first uplink codebook, the first uplink codebook being based on a first antenna configuration of the user equipment and a first oversampling factor.

At block 1704, the user equipment may transmit an uplink transmission based on the TPMI to the network entity. In some examples, the codebook processing circuitry 1443 together with the communication and processing circuitry 1441 and the transceiver 1410, shown and described in FIG. 14, may provide a means to transmit an uplink transmission based on the TPMI to the network entity.

In some examples, the user equipment may transmit a first indication of the first antenna configuration to the network entity. In some examples, the user equipment may receive a second indication of a codebook set including the first uplink codebook from the network entity, the codebook set being based on the first antenna configuration.

In some examples, the first antenna configuration may include a uniform planar array with eight antenna elements. In some examples, the first antenna configuration may include a uniform planar array including two antenna elements in a horizontal domain and two antenna elements in a vertical domain. In some examples, the first oversampling factor is a value of two.

In some examples, the first antenna configuration may include a uniform planar array including two antenna elements in a horizontal domain and two antenna elements in a vertical domain. In some examples, the first oversampling factor is a value of one.

In some examples, the first antenna configuration may include a uniform linear array with eight antenna elements. In some examples, the first antenna configuration may include a uniform linear array including four antenna elements in a horizontal domain and one antenna element in a vertical domain. In some examples, the first oversampling factor is a value of one.

Referring again to FIG. 14, in one configuration, the UE 1400 includes means for receiving a downlink transmission based on a first downlink codebook from a network entity, the first downlink codebook being based on a first oversampling factor, and means for transmitting an uplink transmission based on a first uplink codebook to the network entity, the first uplink codebook being based on a first antenna configuration and a second oversampling factor, the second oversampling factor being different from the first oversampling factor. In one configuration, the UE 1400 includes means for transmitting a first indication of a first antenna configuration associated with the user equipment to a network entity, means for receiving a second indication of a codebook set for uplink transmissions from the network entity, the codebook set being based on the first antenna configuration, and means for transmitting a first uplink transmission based on a first uplink codebook of the codebook set to the network entity. In one configuration, the UE 1400 includes means for receiving a transmitted precoder matrix index (TPMI) from a network entity, the TPMI being associated with a first uplink codebook, the first uplink codebook being based on a first antenna configuration of the user equipment and a first oversampling factor, and means for transmitting an uplink transmission based on the TPMI to the network entity. In one aspect, the aforementioned means may be the processor 1404 shown in FIG. 14 configured to perform the functions recited by the aforementioned means (e.g., as discussed above). In another aspect, the aforementioned means may be a circuit or any apparatus configured to perform the functions recited by the aforementioned means.

Of course, in the above examples, the circuitry included in the processor 1404 is merely provided as an example, and other means for carrying out the described functions may be included within various aspects of the present disclosure, including but not limited to the instructions stored in the computer-readable medium 1406, or any other suitable apparatus or means described in any one or more of FIGS. 1, 2, 3, 8, 13, and 14, and utilizing, for example, the methods and/or algorithms described herein in relation to FIGS. 15-17.

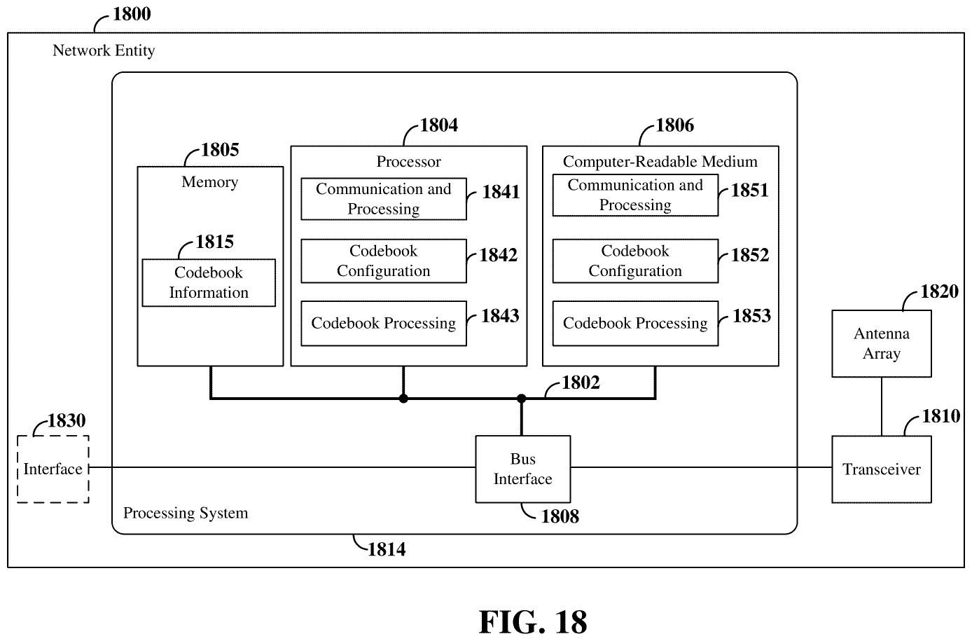

FIG. 18 is a conceptual diagram illustrating an example of a hardware implementation for a network entity 1800 employing a processing system 1814. In some implementations, the network entity 1800 may correspond to any of the network entities, base stations, CUs, DUs, RUs, or scheduling entities shown in any of FIGS. 1, 2, 3, 8, and 13.

In accordance with various aspects of the disclosure, an element, or any portion of an element, or any combination of elements may be implemented with the processing system 1814. The processing system may include one or more processors 1804. The processing system 1814 may be substantially the same as the processing system 1414 illustrated in FIG. 14, including a bus interface 1808, a bus 1802, memory 1805, a processor 1804, a computer-readable medium 1806, a transceiver 1810, and an antenna array 1820. The memory 1805 may store codebook information 1815 (e.g., precoders) used by the processor 1804 in cooperation with the transceiver 1810 for communication operations as described herein. Furthermore, the network entity 1800 may include an interface 1830 (e.g., a network interface) that provides a means for communicating with at least one other apparatus within a core network and with at least one radio access network.

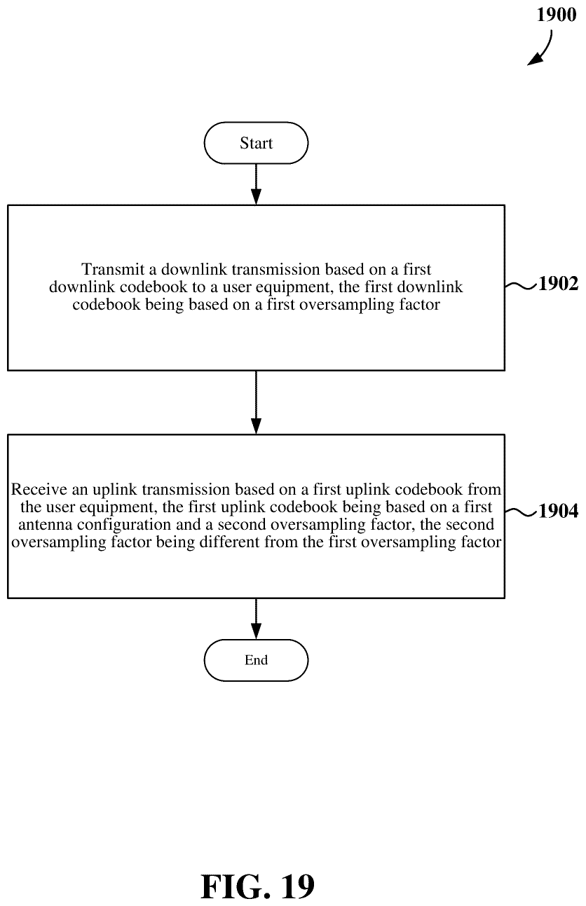

The network entity 1800 may be configured to perform any one or more of the operations described herein (e.g., as described above in conjunction with FIGS. 1-13 and as described below in conjunction with FIGS. 19-21). In some aspects of the disclosure, the processor 1804, as utilized in the network entity 1800, may include circuitry configured for various functions.

The processor 1804 may be configured to generate, schedule, and modify a resource assignment or grant of time-frequency resources (e.g., a set of one or more resource elements). For example, the processor 1804 may schedule time-frequency resources within a plurality of time division duplex (TDD) and/or frequency division duplex (FDD) subframes, slots, and/or mini-slots to carry user data traffic and/or control information to and/or from multiple scheduled entities. The processor 1804 may be configured to schedule resources for the transmission of downlink signals. The processor 1804 may further be configured to schedule resources for the transmission of uplink signals.

In some aspects of the disclosure, the processor 1804 may include communication and processing circuitry 1841. The communication and processing circuitry 1841 may be configured to communicate with a user equipment. The communication and processing circuitry 1841 may include one or more hardware components that provide the physical structure that performs various processes related to communication (e.g., signal reception and/or signal transmission) as described herein. The communication and processing circuitry 1841 may further include one or more hardware components that provide the physical structure that performs various processes related to signal processing (e.g., processing a received signal and/or processing a signal for transmission) as described herein. The communication and processing circuitry 1841 may further be configured to execute communication and processing software 1851 included on the computer-readable medium 1806 to implement one or more functions described herein.

The communication and processing circuitry 1841 may further be configured to receive an indication from the UE. For example, the indication may be included in a MAC-CE carried in a Uu PUSCH or a PSCCH, or included in a Uu RRC message or an SL RRC message, or included in a dedicated Uu PUCCH or PUSCH. The communication and processing circuitry 1841 may further be configured to receive a scheduling request from a UE for an uplink grant or a sidelink grant.

In some implementations wherein the communication involves receiving information, the communication and processing circuitry 1841 may obtain information from a component of the network entity 1800 (e.g., from the transceiver 1810 that receives the information via radio frequency signaling or some other type of signaling suitable for the applicable communication medium), process (e.g., decode) the information, and output the processed information. For example, the communication and processing circuitry 1841 may output the information to another component of the processor 1804, to the memory 1805, or to the bus interface 1808. In some examples, the communication and processing circuitry 1841 may receive one or more of signals, messages, other information, or any combination thereof. In some examples, the communication and processing circuitry 1841 may receive information via one or more channels. In some examples, the communication and processing circuitry 1841 may include functionality for a means for receiving. In some examples, the communication and processing circuitry 1841 may include functionality for a means for decoding. In some examples, the communication and processing circuitry 1841 and/or the transceiver 1810 may include functionality for a means for receiving an uplink transmission.

In some implementations wherein the communication involves sending (e.g., transmitting) information, the communication and processing circuitry 1841 may obtain information (e.g., from another component of the processor 1804, the memory 1805, or the bus interface 1808), process (e.g., encode) the information, and output the processed information. For example, the communication and processing circuitry 1841 may output the information to the transceiver 1810 (e.g., that transmits the information via radio frequency signaling or some other type of signaling suitable for the applicable communication medium). In some examples, the communication and processing circuitry 1841 may send one or more of signals, messages, other information, or any combination thereof. In some examples, the communication and processing circuitry 1841 may send information via one or more channels. In some examples, the communication and processing circuitry 1841 may include functionality for a means for sending (e.g., a means for transmitting). In some examples, the communication and processing circuitry 1841 may include functionality for a means for encoding. In some examples, the communication and processing circuitry 1841 and/or the transceiver 1810 may include functionality for a means for transmitting a downlink transmission.

The processor 1804 may include codebook configuration circuitry 1842 configured to perform codebook configuration-related operations as discussed herein (e.g., one or more of the operations described above in conjunction with FIGS. 8-13). The codebook configuration circuitry 1842 may be configured to execute codebook configuration software 1852 included on the computer-readable medium 1806 to implement one or more functions described herein.

The codebook configuration circuitry 1842 may include functionality for a means for receiving configuration information (e.g., as described above in conjunction with FIGS. 8-13). For example, the codebook configuration circuitry 1842 may receive an RRC message including antenna configuration information from a UE via a PUSCH.

The codebook configuration circuitry 1842 may include functionality for a means for transmitting codebook information (e.g., as described above in conjunction with FIGS. 8-13). For example, the codebook configuration circuitry 1842 may transmit an RRC message including codebook information to a UE via a PDSCH. As another example, the codebook configuration circuitry 1842 may transmit a DCI including a TPMI to a UE via a PDCCH.

The processor 1804 may include codebook processing circuitry 1843 configured to perform codebook processing-related operations as discussed herein (e.g., one or more of the operations described above in conjunction with FIGS. 8-13). The codebook processing circuitry 1843 may be configured to execute codebook processing software 1853 included on the computer-readable medium 1806 to implement one or more functions described herein.

The codebook processing circuitry 1843 may include functionality for a means for transmitting a downlink transmission (e.g., as described above in conjunction with FIGS. 8-13). For example, the codebook processing circuitry 1843 may identify, from a downlink codebook, a precoder to be used for a downlink transmission to UE.

The codebook processing circuitry 1843 may include functionality for a means for receiving an uplink transmission (e.g., as described above in conjunction with FIGS. 8-13). For example, the codebook processing circuitry 1843 may receive an uplink transmission that was precoded using an uplink codebook.

In some examples, the network entity 1800 shown and described above in connection with FIG. 18 may be a disaggregated base station. For example, the network entity 1800 shown in FIG. 18 may include the CU and optionally one or more DUs/RUs of the disaggregated base station. Other DUs/RUs associated with the network entity 1800 may be distributed throughout the network. In some examples, the DUs/RUs may correspond to TRPs associated with the network entity. In some examples, the CU and/or DU/RU of the disaggregated base station (e.g., within the network entity 1800) may generate a DCI (e.g., including a TPMI) and provide the DCI to a user equipment, as well as receive and process uplink transmissions based on the TPMI from the user equipment.

FIG. 19 is a flow chart illustrating an example method 1900 for a wireless communication system in accordance with some aspects of the present disclosure. As described below, some or all illustrated features may be omitted in a particular implementation within the scope of the present disclosure, and some illustrated features may not be required for implementation of all examples. In some examples, the method 1900 may be carried out by the network entity 1800 illustrated in FIG. 18. In some examples, the method 1900 may be carried out by any suitable apparatus or means for carrying out the functions or algorithm described below.

At block 1902, a network entity may transmit a downlink transmission based on a first downlink codebook to a user equipment, the first downlink codebook being based on a first oversampling factor. In some examples, the codebook processing circuitry 1843 together with the communication and processing circuitry 1841 and the transceiver 1810, shown and described in FIG. 18, may provide a means to transmit a downlink transmission based on a first downlink codebook to a user equipment, the first downlink codebook being based on a first oversampling factor.

At block 1904, the network entity may receive an uplink transmission based on a first uplink codebook from the user equipment, the first uplink codebook being based on a first antenna configuration and a second oversampling factor, the second oversampling factor being different from the first oversampling factor. In some examples, the codebook processing circuitry 1843 together with the communication and processing circuitry 1841 and the transceiver 1810, shown and described in FIG. 18, may provide a means to receive an uplink transmission based on a first uplink codebook from the user equipment, the first uplink codebook being based on a first antenna configuration and a second oversampling factor, the second oversampling factor being different from the first oversampling factor.

In some examples, the network entity may receive a first indication of the first antenna configuration from the user equipment. In some examples, the network entity may identify a codebook set based on the first antenna configuration, the codebook set including the first uplink codebook. In some examples, identifying a codebook set may include generating a codebook set. In some examples, the network entity may transmit a second indication of the codebook set to the user equipment. In some examples, the first antenna configuration is an antenna configuration of the user equipment. In some examples, the downlink transmission is based on an antenna configuration of the network entity.

In some examples, the first antenna configuration may include a uniform planar array with eight antenna elements. In some examples, the first antenna configuration may include a uniform planar array including two antenna elements in a horizontal domain and two antenna elements in a vertical domain. In some examples, the first oversampling factor is a value of four. In some examples, the second oversampling factor is a value of two.

In some examples, the first antenna configuration may include a uniform planar array including two antenna elements in a horizontal domain and two antenna elements in a vertical domain. In some examples, the first oversampling factor is a value of four. In some examples, the second oversampling factor is a value of one.

In some examples, the first antenna configuration may include a uniform linear array with eight antenna elements. In some examples, the first antenna configuration may include a uniform linear array including four antenna elements in a horizontal domain and one antenna element in a vertical domain. In some examples, the first oversampling factor is a value of four. In some examples, the second oversampling factor is a value of one.

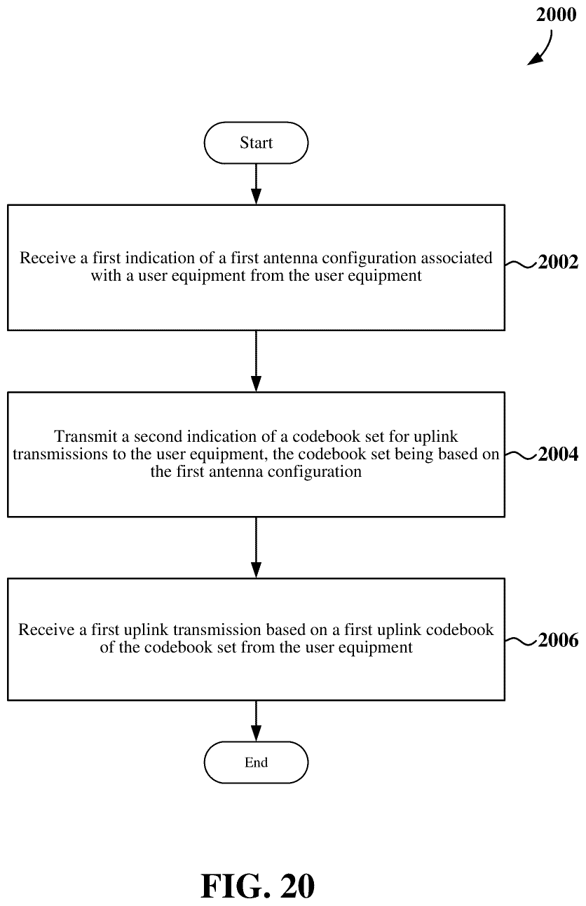

FIG. 20 is a flow chart illustrating an example method 2000 for a wireless communication system in accordance with some aspects of the present disclosure. As described below, some or all illustrated features may be omitted in a particular implementation within the scope of the present disclosure, and some illustrated features may not be required for implementation of all examples. In some examples, the method 2000 may be carried out by the network entity 1800 illustrated in FIG. 18. In some examples, the method 2000 may be carried out by any suitable apparatus or means for carrying out the functions or algorithm described below.

At block 2002, a network entity may receive a first indication of a first antenna configuration associated with a user equipment from the user equipment. In some examples, the codebook configuration circuitry 1842 together with the communication and processing circuitry 1841 and the transceiver 1810, shown and described in FIG. 18, may provide a means to receive a first indication of a first antenna configuration associated with a user equipment from the user equipment.

At block 2004, the network entity may transmit a second indication of a codebook set for uplink transmissions to the user equipment, the codebook set being based on the first antenna configuration. In some examples, the codebook configuration circuitry 1842 together with the communication and processing circuitry 1841 and the transceiver 1810, shown and described in FIG. 18, may provide a means to transmit a second indication of a codebook set for uplink transmissions to the user equipment, the codebook set being based on the first antenna configuration.

At block 2006, the network entity may receive a first uplink transmission based on a first uplink codebook of the codebook set from the user equipment. In some examples, the codebook processing circuitry 1843 together with the communication and processing circuitry 1841 and the transceiver 1810, shown and described in FIG. 18, may provide a means to receive a first uplink transmission based on a first uplink codebook of the codebook set from the user equipment.

In some examples, the first antenna configuration may include a uniform planar array with eight antenna elements. In some examples, the first antenna configuration may include a uniform planar array including two antenna elements in a horizontal domain and two antenna elements in a vertical domain. In some examples, the first uplink codebook is based on an oversampling factor value of two.

In some examples, the first antenna configuration may include a uniform planar array including two antenna elements in a horizontal domain and two antenna elements in a vertical domain. In some examples, the first uplink codebook is based on an oversampling factor value of one.

In some examples, the first antenna configuration may include a uniform linear array with eight antenna elements. In some examples, the first antenna configuration may include a uniform linear array including four antenna elements in a horizontal domain and one antenna element in a vertical domain. In some examples, the first uplink codebook is based on an oversampling factor value of one.

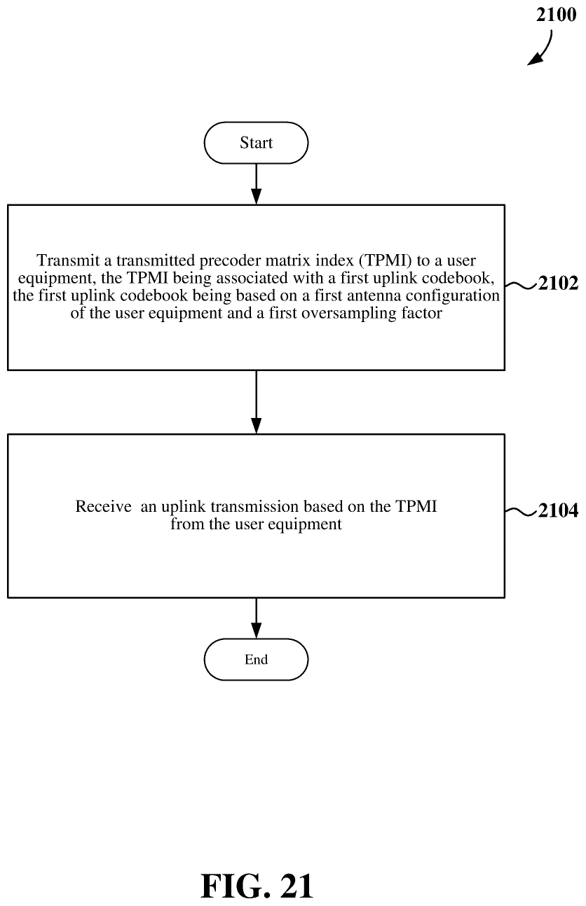

FIG. 21 is a flow chart illustrating an example method 2100 for a wireless communication system in accordance with some aspects of the present disclosure. As described below, some or all illustrated features may be omitted in a particular implementation within the scope of the present disclosure, and some illustrated features may not be required for implementation of all examples. In some examples, the method 2100 may be carried out by the network entity 1800 illustrated in FIG. 18. In some examples, the method 2100 may be carried out by any suitable apparatus or means for carrying out the functions or algorithm described below.

At block 2102, a network entity may transmit a transmitted precoder matrix index (TPMI) to a user equipment, the TPMI being associated with a first uplink codebook, the first uplink codebook being based on a first antenna configuration of the user equipment and a first oversampling factor. In some examples, the codebook processing circuitry 1843 together with the communication and processing circuitry 1841 and the transceiver 1810, shown and described in FIG. 18, may provide a means to transmit a transmitted precoder matrix index (TPMI) to a user equipment, the TPMI being associated with a first uplink codebook, the first uplink codebook being based on a first antenna configuration of the user equipment and a first oversampling factor.

At block 2104, the network entity may receive an uplink transmission based on the TPMI from the user equipment. In some examples, the codebook processing circuitry 1843 together with the communication and processing circuitry 1841 and the transceiver 1810, shown and described in FIG. 18, may provide a means to receive an uplink transmission based on the TPMI from the user equipment.

In some examples, the network entity may receive a first indication of the first antenna configuration from the user equipment. In some examples, the network entity may identify a codebook set based on the first antenna configuration, the codebook set including the first uplink codebook. In some examples, identifying a codebook set may include generating a codebook set. In some examples, the network entity may transmit a second indication of the codebook set to the user equipment.

In some examples, the first antenna configuration may include a uniform planar array with eight antenna elements. In some examples, the first antenna configuration may include a uniform planar array including two antenna elements in a horizontal domain and two antenna elements in a vertical domain. In some examples, the first oversampling factor is a value of two.

In some examples, the first antenna configuration may include a uniform planar array including two antenna elements in a horizontal domain and two antenna elements in a vertical domain. In some examples, the first oversampling factor is a value of one.

In some examples, the first antenna configuration may include a uniform linear array with eight antenna elements. In some examples, the first antenna configuration may include a uniform linear array including four antenna elements in a horizontal domain and one antenna element in a vertical domain. In some examples, the first oversampling factor is a value of one.

Referring again to FIG. 18, in one configuration, the network entity 1800 includes means for transmitting a downlink transmission based on a first downlink codebook to a user equipment, the first downlink codebook being based on a first oversampling factor, and means for receiving an uplink transmission based on a first uplink codebook from the user equipment, the first uplink codebook being based on a first antenna configuration and a second oversampling factor, the second oversampling factor being different from the first oversampling factor. In one configuration, the network entity 1800 includes means for receiving a first indication of a first antenna configuration associated with a user equipment from the user equipment, means for transmitting a second indication of a codebook set for uplink transmissions to the user equipment, the codebook set being based on the first antenna configuration, and means for receiving a message from the user equipment based on the timing advance information. In one configuration, the network entity 1800 includes means for transmitting a transmitted precoder matrix index (TPMI) to a user equipment, the TPMI being associated with a first uplink codebook, the first uplink codebook being based on a first antenna configuration of the user equipment and a first oversampling factor, and means for receiving an uplink transmission based on the TPMI from the user equipment. In one aspect, the aforementioned means may be the processor 1804 shown in FIG. 18 configured to perform the functions recited by the aforementioned means (e.g., as discussed above). In another aspect, the aforementioned means may be a circuit or any apparatus configured to perform the functions recited by the aforementioned means.

Of course, in the above examples, the circuitry included in the processor 1804 is merely provided as an example, and other means for carrying out the described functions may be included within various aspects of the present disclosure, including but not limited to the instructions stored in the computer-readable medium 1806, or any other suitable apparatus or means described in any one or more of FIGS. 1, 2, 3, 8, 13, and 18, and utilizing, for example, the methods and/or algorithms described herein in relation to FIGS. 19-21.

The methods shown in FIGS. 15-17 and 19-21 may include additional aspects, such as any single aspect or any combination of aspects described below and/or in connection with one or more other processes described elsewhere herein. The following provides an overview of several aspects of the present disclosure.

Aspect 1: A method for wireless communication at a user equipment, the method comprising: receiving a transmitted precoder matrix index (TPMI) from a network entity, the TPMI being associated with a first uplink codebook, the first uplink codebook being based on a first antenna configuration of the user equipment and a first oversampling factor; and transmitting an uplink transmission based on the TPMI to the network entity.

Aspect 2: The method of aspect 1, further comprising: transmitting a first indication of the first antenna configuration to the network entity.

Aspect 3: The method of aspect 2, further comprising: receiving a second indication of a codebook set including the first uplink codebook from the network entity, the codebook set being based on the first antenna configuration.

Aspect 4: The method of any of aspects 1 through 3, wherein the first antenna configuration comprises a uniform planar array with eight antenna elements.

Aspect 5: The method of any of aspects 1 through 4, wherein: the first antenna configuration comprises a uniform planar array including two antenna elements in a horizontal domain and two antenna elements in a vertical domain; and the first oversampling factor is a value of two.

Aspect 6: The method of any of aspects 1 through 4, wherein: the first antenna configuration comprises a uniform planar array including two antenna elements in a horizontal domain and two antenna elements in a vertical domain; and the first oversampling factor is a value of one.

Aspect 7: The method of any of aspects 1 through 3, wherein the first antenna configuration comprises a uniform linear array with eight antenna elements.

Aspect 8: The method of any of aspects 1 through 3 and 7, wherein: the first antenna configuration comprises a uniform linear array including four antenna elements in a horizontal domain and one antenna element in a vertical domain; and the first oversampling factor is a value of one.

Aspect 9: A method for wireless communication at a network entity, the method comprising: transmitting a transmitted precoder matrix index (TPMI) to a user equipment, the TPMI being associated with a first uplink codebook, the first uplink codebook being based on a first antenna configuration of the user equipment and a first oversampling factor; and receiving an uplink transmission based on the TPMI from the user equipment.

Aspect 10: The method of aspect 9, further comprising: receiving a first indication of the first antenna configuration from the user equipment.

Aspect 11: The method of aspect 10, further comprising: identifying a codebook set based on the first antenna configuration, the codebook set including the first uplink codebook; and transmitting a second indication of the codebook set to the user equipment.

Aspect 12: The method of any of aspects 9 through 11, wherein the first antenna configuration comprises a uniform planar array with eight antenna elements.

Aspect 13: The method of any of aspects 9 through 12, wherein: the first antenna configuration comprises a uniform planar array including two antenna elements in a horizontal domain and two antenna elements in a vertical domain; and the first oversampling factor is a value of two.

Aspect 14: The method of any of aspects 9 through 12, wherein: the first antenna configuration comprises a uniform planar array including two antenna elements in a horizontal domain and two antenna elements in a vertical domain; and the first oversampling factor is a value of one.

Aspect 15: The method of any of aspects 9 through 11, wherein the first antenna configuration comprises a uniform linear array with eight antenna elements.

Aspect 16: The method of any of aspects 9 through 11 and 15, wherein: the first antenna configuration comprises a uniform linear array including four antenna elements in a horizontal domain and one antenna element in a vertical domain; and the first oversampling factor is a value of one.

Aspect 17: A method for wireless communication at a user equipment, the method comprising: transmitting a first indication of a first antenna configuration associated with the user equipment to a network entity; receiving a second indication of a codebook set for uplink transmissions from the network entity, the codebook set being based on the first antenna configuration; and transmitting a first uplink transmission based on a first uplink codebook of the codebook set to the network entity.

Aspect 18: The method of aspect 17, wherein the first antenna configuration comprises a uniform planar array with eight antenna elements.

Aspect 19: The method of any of aspects 17 through 18, wherein: the first antenna configuration comprises a uniform planar array including two antenna elements in a horizontal domain and two antenna elements in a vertical domain; and the first uplink codebook is based on an oversampling factor value of two.

Aspect 20: The method of any of aspects 17 through 18, wherein: the first antenna configuration comprises a uniform planar array including two antenna elements in a horizontal domain and two antenna elements in a vertical domain; and the first uplink codebook is based on an oversampling factor value of one.

Aspect 21: The method of aspect 17, wherein the first antenna configuration comprises a uniform linear array with eight antenna elements.

Aspect 22: The method of any of aspects 18 and 21, wherein: the first antenna configuration comprises a uniform linear array including four antenna elements in a horizontal domain and one antenna element in a vertical domain; and the first uplink codebook is based on an oversampling factor value of one.

Aspect 23: The method of any of aspects 17 through 22, further comprising: transmitting a transmitted precoder matrix index (TPMI) associated with the first uplink codebook to the user equipment.

Aspect 24: A method for wireless communication at a network entity, the method comprising: receiving a first indication of a first antenna configuration associated with a user equipment from the user equipment; transmitting a second indication of a codebook set for uplink transmissions to the user equipment, the codebook set being based on the first antenna configuration; and receiving a first uplink transmission based on a first uplink codebook of the codebook set from the user equipment.

Aspect 25: The method of aspect 24, wherein the first antenna configuration comprises a uniform planar array with eight antenna elements.

Aspect 26: The method of any of aspects 24 through 25, wherein: the first antenna configuration comprises a uniform planar array including two antenna elements in a horizontal domain and two antenna elements in a vertical domain; and the first uplink codebook is based on an oversampling factor value of two.

Aspect 27: The method of any of aspects 24 through 25, wherein: the first antenna configuration comprises a uniform planar array including two antenna elements in a horizontal domain and two antenna elements in a vertical domain; and the first uplink codebook is based on an oversampling factor value of one.

Aspect 28: The method of aspect 24, wherein the first antenna configuration comprises a uniform linear array with eight antenna elements.

Aspect 29: The method of any of aspects 24 and 28, wherein: the first antenna configuration comprises a uniform linear array including four antenna elements in a horizontal domain and one antenna element in a vertical domain; and the first uplink codebook is based on an oversampling factor value of one.

Aspect 30: The method of any of aspects 24 through 29, further comprising: transmitting a transmitted precoder matrix index (TPMI) associated with the first uplink codebook to the user equipment.

Aspect 31: A user equipment comprising: a transceiver configured to communicate with a radio access network, a memory, and a processor coupled to the transceiver and the memory, wherein the processor and the memory are configured to perform any one or more of aspects 1 through 8.

Aspect 32: An apparatus configured for wireless communication comprising at least one means for performing any one or more of aspects 1 through 8.

Aspect 33: A non-transitory computer-readable medium storing computer-executable code, comprising code for causing an apparatus to perform any one or more of aspects 1 through 8.

Aspect 34: A network entity comprising: a transceiver, a memory, and a processor coupled to the transceiver and the memory, wherein the processor and the memory are configured to perform any one or more of aspects 9 through 16.

Aspect 35: An apparatus configured for wireless communication comprising at least one means for performing any one or more of aspects 9 through 16.

Aspect 36: A non-transitory computer-readable medium storing computer-executable code, comprising code for causing an apparatus to perform any one or more of aspects 9 through 16.

Aspect 37: A user equipment comprising: a transceiver configured to communicate with a radio access network, a memory, and a processor coupled to the transceiver and the memory, wherein the processor and the memory are configured to perform any one or more of aspects 17 through 23.

Aspect 38: An apparatus configured for wireless communication comprising at least one means for performing any one or more of aspects 17 through 23.

Aspect 39: A non-transitory computer-readable medium storing computer-executable code, comprising code for causing an apparatus to perform any one or more of aspects 17 through 23.

Aspect 40: A network entity comprising: a transceiver, a memory, and a processor coupled to the transceiver and the memory, wherein the processor and the memory are configured to perform any one or more of aspects 24 through 30.

Aspect 41: An apparatus configured for wireless communication comprising at least one means for performing any one or more of aspects 24 through 30.

Aspect 42: A non-transitory computer-readable medium storing computer-executable code, comprising code for causing an apparatus to perform any one or more of aspects 24 through 30.

Several aspects of a wireless communication network have been presented with reference to an example implementation. As those skilled in the art will readily appreciate, various aspects described throughout this disclosure may be extended to other telecommunication systems, network architectures and communication standards.

By way of example, various aspects may be implemented within other systems defined by 3GPP, such as Long-Term Evolution (LTE), the Evolved Packet System (EPS), the Universal Mobile Telecommunication System (UMTS), and/or the Global System for Mobile (GSM). Various aspects may also be extended to systems defined by the 3rd Generation Partnership Project 2 (3GPP2), such as CDMA2000 and/or Evolution-Data Optimized (EV-DO). Other examples may be implemented within systems employing Institute of Electrical and Electronics Engineers (IEEE) 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another-even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure. As used herein, the term “determining” may include, for example, ascertaining, resolving, selecting, choosing, establishing, calculating, computing, processing, deriving, investigating, looking up (e.g., looking up in a table, a database or another data structure), and the like. Also, “determining” may include receiving (e.g., receiving information), accessing (e.g., accessing data in a memory), and the like.

One or more of the components, steps, features and/or functions illustrated in FIGS. 1-21 may be rearranged and/or combined into a single component, step, feature or function or embodied in several components, steps, or functions. Additional elements, components, steps, and/or functions may also be added without departing from novel features disclosed herein. The apparatus, devices, and/or components illustrated in FIGS. 1, 2, 3, 8, 13, 14, and 18 may be configured to perform one or more of the methods, features, or steps escribed herein. The novel algorithms described herein may also be efficiently implemented in software and/or embedded in hardware.

It is to be understood that the specific order or hierarchy of steps in the methods disclosed is an illustration of example processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” (e.g., comprising at least one of or comprises at least one of) a list of items refers to any combination of those items, including single members. As an example, “at least one of: a, b, or c” is intended to cover: a; b; c; a and b; a and c; b and c; and a, b, and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A user equipment, comprising:
a memory; and
a processor coupled to the memory, wherein the processor and the memory are configured to:
receive a transmitted precoder matrix index (TPMI) from a network entity, the TPMI being associated with a first uplink codebook, the first uplink codebook being based on a first antenna configuration of the user equipment and a first oversampling factor; and
transmit an uplink transmission based on the TPMI to the network entity.

2. The user equipment of claim 1, wherein the processor and the memory are further configured to:
transmit a first indication of the first antenna configuration to the network entity.

3. The user equipment of claim 2, wherein the processor and the memory are further configured to:
receive a second indication of a codebook set including the first uplink codebook from the network entity, the codebook set being based on the first antenna configuration.

4. The user equipment of claim 1, wherein the first antenna configuration comprises a uniform planar array with eight antenna elements.

5. The user equipment of claim 1, wherein:
the first antenna configuration comprises a uniform planar array including two antenna elements in a horizontal domain and two antenna elements in a vertical domain;
the first oversampling factor is a value of two.

6. The user equipment of claim 1, wherein:
the first antenna configuration comprises a uniform planar array including two antenna elements in a horizontal domain and two antenna elements in a vertical domain;
the first oversampling factor is a value of one.

7. The user equipment of claim 1, wherein the first antenna configuration comprises a uniform linear array with eight antenna elements.

8. The user equipment of claim 1, wherein:
the first antenna configuration comprises a uniform linear array including four antenna elements in a horizontal domain and one antenna element in a vertical domain;
the first oversampling factor is a value of one.

9. A network entity, comprising:
a memory; and
a processor coupled to the memory, wherein the processor and the memory are configured to:
transmit a transmitted precoder matrix index (TPMI) to a user equipment, the TPMI being associated with a first uplink codebook, the first uplink codebook being based on a first antenna configuration of the user equipment and a first oversampling factor; and
receive an uplink transmission based on the TPMI from the user equipment.

10. The network entity of claim 9, wherein the processor and the memory are further configured to:
receive a first indication of the first antenna configuration from the user equipment.

11. The network entity of claim 10, wherein the processor and the memory are further configured to:
identify a codebook set based on the first antenna configuration, the codebook set including the first uplink codebook; and
transmit a second indication of the codebook set to the user equipment.

12. The network entity of claim 9, wherein the first antenna configuration comprises a uniform planar array with eight antenna elements.

13. The network entity of claim 9, wherein:
the first antenna configuration comprises a uniform planar array including two antenna elements in a horizontal domain and two antenna elements in a vertical domain;
the first oversampling factor is a value of two.

14. The network entity of claim 9, wherein:
the first antenna configuration comprises a uniform planar array including two antenna elements in a horizontal domain and two antenna elements in a vertical domain;
the first oversampling factor is a value of one.

15. The network entity of claim 9, wherein the first antenna configuration comprises a uniform linear array with eight antenna elements.

16. The network entity of claim 9, wherein:
the first antenna configuration comprises a uniform linear array including four antenna elements in a horizontal domain and one antenna element in a vertical domain;
the first oversampling factor is a value of one.

17. A user equipment, comprising:
a memory; and
a processor coupled to the memory, wherein the processor and the memory are configured to:
transmit a first indication of a first antenna configuration associated with the user equipment to a network entity;
receive a second indication of a codebook set for uplink transmissions from the network entity, the codebook set being based on the first antenna configuration; and
transmit a first uplink transmission based on a first uplink codebook of the codebook set to the network entity.

18. The user equipment of claim 17, wherein the first antenna configuration comprises a uniform planar array with eight antenna elements.

19. The user equipment of claim 17, wherein:
the first antenna configuration comprises a uniform planar array including two antenna elements in a horizontal domain and two antenna elements in a vertical domain; and
the first uplink codebook is based on an oversampling factor value of two.

20. The user equipment of claim 17, wherein:
the first antenna configuration comprises a uniform planar array including two antenna elements in a horizontal domain and two antenna elements in a vertical domain; and
the first uplink codebook is based on an oversampling factor value of one.

21. The user equipment of claim 17, wherein the first antenna configuration comprises a uniform linear array with eight antenna elements.

22. The user equipment of claim 17, wherein:
the first antenna configuration comprises a uniform linear array including four antenna elements in a horizontal domain and one antenna element in a vertical domain; and
the first uplink codebook is based on an oversampling factor value of one.

23. The user equipment of claim 17, wherein the processor and the memory are further configured to:
transmit a transmitted precoder matrix index (TPMI) associated with the first uplink codebook to the user equipment.

24. A network entity, comprising:
a memory; and
a processor coupled to the memory, wherein the processor and the memory are configured to:
receive a first indication of a first antenna configuration associated with a user equipment from the user equipment;
transmit a second indication of a codebook set for uplink transmissions to the user equipment, the codebook set being based on the first antenna configuration; and
receive a first uplink transmission based on a first uplink codebook of the codebook set from the user equipment.

25. The network entity of claim 24, wherein the first antenna configuration comprises a uniform planar array with eight antenna elements.

26. The network entity of claim 24, wherein:
the first antenna configuration comprises a uniform planar array including two antenna elements in a horizontal domain and two antenna elements in a vertical domain; and
the first uplink codebook is based on an oversampling factor value of two.

27. The network entity of claim 24, wherein:
the first antenna configuration comprises a uniform planar array including two antenna elements in a horizontal domain and two antenna elements in a vertical domain; and
the first uplink codebook is based on an oversampling factor value of one.

28. The network entity of claim 24, wherein the first antenna configuration comprises a uniform linear array with eight antenna elements.

29. The network entity of claim 24, wherein:
the first antenna configuration comprises a uniform linear array including four antenna elements in a horizontal domain and one antenna element in a vertical domain; and
the first uplink codebook is based on an oversampling factor value of one.

30. The network entity of claim 24, wherein the processor and the memory are further configured to:
transmit a transmitted precoder matrix index (TPMI) associated with the first uplink codebook to the user equipment.
